SEQUENCE LISTING (5 sequences)

SEQ ID NO: 1 - protein, 612 aa, Aspergillus fumigatus
APQLSARATGSLDSWLGTETTVALNGILANIGADGAYAKSAKPGIIIASPSTSEPDYYYTWTRDAALVTKVLVDLFRNGNLGLQKVITEYVNSQAYLQTVSNPSGGLASGGLAEPKYNVDMTAFTGAWGRPQRDGPALRATALIDFGNWLIDNGYSSYAVNNIWPIVRNDLSYVSQYWSQSGFDLWEEVNSMSFFTVAVQHRALVEGSTFAKRVGASCSWCDSQAPQILCYMQSFWTGSYINANTGGGRSGKDANTVLASIHTFDPEAGCDDTTFQPCSPRALANHKVYTDSFRSVYAINSGIPQGAAVSAGRYPEDVYYNGNPWFLTTLAAAEQLYDAIYQWKKIGSISITSTSLAFFKDIYSSAAVGTYASSTSTFTDIINAVKTYADGYVSIVQAHAMNNGSLSEQFDKSSGLSLSARDLTWSYAAFLTANMRRNGVVPAPWGAASANSVPSSCSMGSATGTYSTATATSWPSTLTSGSPGSTTTVGTTTSTTSGTAAETACATPTAVAVTFNEIATTTYGENVYIVGSISELGNWDTSKAVALSASKYTSSNNLWYVSVTLPAGTTFEYKYIRKESDGSIVWESDPNRSYTVPAACGVSTATENDTWQ

SEQ ID NO: 2 - protein, 616 aa, Aspergillus niger
ATLDSWLSNEATVARTAILNNIGADGAWVSGADSGIVVASPSTDNPDYFYTWTRDSGLVLKTLVDLFRNGDTSLLSTIENYISAQAIVQGISNPSGDLSSGAGLGEPKFNVDETAYTGSWGRPQRDGPALRATAMIGFGQWLLDNGYTSTATDIVWPLVRNDLSYVAQYWNQTGYDLWEEVNGSSFFTIAVQHRALVEGSAFATAVGSSCSWCDSQAPEILCYLQSFWTGSFILANFDSSRSGKDANTLLGSIHTFDPEAACDDSTFQPCSPRALANHKEVVDSFRSIYTLNDGLSDSEAVAVGRYPEDTYYNGNPWFLCTLAAAEQLYDALYQWDKQGSLEVTDVSLDFFKALYSDAATGTYSSSSSTYSSIVDAVKTFADGFVSIVETHAASNGSMSEQYDKSDGEQLSARDLTWSYAALLTANNRRNSVVPASWGETSASSVPGTCAATSAIGTYSSVTVTSWPSIVATGGTTTTATPTGSGSVTSTSKTTATASKTSTSTSSTSCTTPTAVAVTFDLTATTTYGENIYLVGSISQLGDWETSDGIALSADKYTSSDPLWYVTVTLPAGESFEYKFIRIESDDSVEWESDPNREYTVPQACGTSTATVTDTWR

SEQ ID NO: 3 - protein, 599 aa, Trichoderma reesei
SVDDFISTETPIALNNLLCNVGPDGCRAFGTSAGAVIASPSTIDPDYYYMWTRDSALVFKNLIDRFTETYDAGLQRRIEQYITAQVTLQGLSNPSGSLADGSGLGEPKFELTLKPFTGNWGRPQRDGPALRAIALIGYSKWLINNNYQSTVSNVIWPIVRNDLNYVAQYWNQTGFDLWEEVNGSSFFTVANQHRALVEGATLAATLGQSGSAYSSVAPQVLCFLQRFWVSSGGYVDSNINTNEGRTGKDVNSVLTSIHTFDPNLGCDAGTFQPCSDKALSNLKVVVDSFRSIYGVNKGIPAGAAVAIGRYAEDVYYNGNPWYLATFAAAEQLYDAIYVWKKTGSITVTATSLAFFQELVPGVTAGTYSSSSSTFTNIINAVSTYADGFLSEAAKYVPADGSLAEQFDRNSGTPLSALHLTWSYASFLTATARRAGIVPPSWANSSASTIPSTCSGASVVGSYSRPTATSFPPSQTPKPGVPSGTPYTPLPCATPTSVAVTFHELVSTQFGQTVKVAGNAAALGNWSTSAAVALDAVNYADNHPLWIGTVNLEAGDVVEYKYINVGQDGSVTWESDPNHTYTVPAVACVTQVVKEDTWQS

SEQ ID NO: 4 - protein, 544 aa, Wolfiporia cocos
IASESPIAKAGVLANIGADGSLSSGAYSGIVIASPSTVNPNYLYTWTRDSSLTFMELINQYIYGEDDTLRTLIDEFVSAEATLQQVTNPSGTVSTGGLGEPKFNINETAFTGPWGRPQRDGPALRATAIMAYATYLYENGNTSYVTDTLWPIIELDLGYVAEYWNESTFDLWEEIDSSSFFTTAVQHRALRAGVTFANLIGETSDVSNYQENADDLLCFLQSYWNPTGSYVTANTGGGRSGKDANTLLASIHTFDPDAGCNATTFQPCSDKALSNHKVYVDSFRSLYAINDDISSDAAVATGRYPEDVYYNGNPWYLCTLAAAEQLYDSLIVWKAQGYIEVTSLSLAFFQQFDASVSAGTYDSSSDTYTTLLDAVQTYADGFVLMVAQYTPANGSLSEQYAKADGSPTSAYDLTWSFAAALTAFAARDGKTYGSWGAADLSSTCSGSTDTVAVTFEVQYDTQYGENLYITGSVSQLEDWSADDALIMSSADYPTWSITVDLPPSTLIQYKYLTKYNGDVTWEDDPNNEITTPASGSYTQVDSWH

SEQ ID NO: 5 - protein, 598 aa, Geosmithia ermersonii
RAPVAARATGSLDSFLATETPIALQGVLNNIGPNGADVAGASAGIVVASPSRSDPNYFYSWTRDAALTAKYLVDAFIAGNKDLEQTIQQYISAQAKVQTISNPSGDLSTGGLGEPKFNVNETAFTGPWGRPQRDGPALRATALIAYANYLIDNGEASTADEIIWPIVQNDLSYITQYWNSSTFDLWEEVEGSSFFTTAVQHRALVEGNALATRLNHTCSNCVSQAPQVLCFLQSYWTGSYVLANFGGSGRSGKDVNSILGSIHTFDPAGGCDDSTFQPCSARALANHKVVTDSFRSIYAINSGIAEGSAVAVGRYPEDVYQGGNPWYLATAAAAEQLYDAIYQWKKIGSISITDVSLPFFQDIYPSAAVGTYNSGSTTFNDIISAVQTYGDGYLSIVEKYTPSDGSLTEQFSRTDGTPLSASALTWSYASLLTASARRQSVVPASWGESSASSVPAVCSATSATGPYSTATNTVWPSSGSGSSTTTSSAPCTTPTSVAVTFDEIVSTSYGETIYLAGSIPELGNWSTASAIPLRADAYTNSNPLWYVTVNLPPGTSFEYKFFKNQTDGTIVWEDDPNRSYTVPAYCGQTTAILDDSWQ

(19) United States
(12) Patent Application Publication
(10) Pub. No.: US 2022/0264911 A1
(43) Pub. Date: Aug. 25, 2022

(54) FEED COMPOSITION

(71) Applicant: DuPont Nutrition Biosciences APS, Copenhagen (DK)

(72) Inventors: Shukun YU, BRABRAND (DK); Kathryn Louise TSE, BRABRAND (DK); Wenting LI, NEWARK, DE (US); Leon MARCHAL, LEIDEN (NL); Jouni VILJANEN, KANTVIK (FI); Karsten Matthias KRAGH, BRABRAND (DK); Charlotte HORSMANS POULSEN, BRABRAND (DK)

(21) Appl. No.: 17/625,024

(22) PCT Filed: Jul. 9, 2020
(86) PCT No.: PCT/US2020/041301

§ 371 Date: Jan. 5, 2022

Related U.S. Application Data
(60) Provisional application No. 62/871,814, filed on Jul. 9, 2019.

(51) Int. Cl. A23K 50/10; A23K 10/18; A23K 20/105; A23K 20/158; A23K 20/189; A23K 20/22; A23K 20/24; A23K 40/35

(52) U.S. Cl. CPC A23K 50/10; A23K 10/18; A23K 20/105; A23K 40/35; A23K 20/189; A23K 20/22; A23K 20/24; A23K 20/158

(57) ABSTRACT

Provided herein, inter alia, are granules for inclusion in feed or feed additive compositions as well as methods for making and using the same for improving the performance of a ruminant animal with respect to one or more of improved feed conversion ratio (FCR), improved weight gain, improved feed efficiency, improved carcass quality, and/or improved milk production.

### CROSS-REFERENCE TO RELATED APPLICATIONS

This application claims priority to U.S. Provisional Patent Application No. 62/871,814, filed Jul. 9, 2019, the disclosure of which is incorporated by reference herein in its entirety.

### FIELD OF THE INVENTION

Provided herein, inter alia, are fat-coated granulated feed additive compositions useful for delivering functional enzymes to the small intestines of animals, such as ruminants, as well as methods for making and using the same.

### BACKGROUND

Enzymes have been widely used for some time as additives in feed for monogastric animals to increase nutrient digestion and to reduce the environmental footprint of large-scale animal farming. Inclusion of phytases in feed has been one of the great success stories of this technology, with around 90% market penetration for monogastrics such as poultry and swine. In contrast, however, feed enzymes have seen very limited use as additives in ruminants despite intensive efforts (Meale et al., J. Anim. Sci. 2014. 92:427-442).

Numerous cellulases and hemicellulases have been tested in ruminants for dry matter intake, total tract dry matter digestion, and milk yield (Arriola et al., J. Dairy Sci. 2017. 100:4513-27) but the results showed high variation with no accompanying increase in feed intake and feed efficacy.

It is well known that starch digestion is limited in ruminants compared to monogastrics and there can be many causes to low starch digestibility (Mills et al., J. Dairy Sci. 2017. 100: 4650-4670). Increased starch digestibility in ruminants has been achieved to a limited extent by “flaking” of corn and sorghum. Alpha-amylases can be used to hydrolyze (1,4)-α-D-glucosidic linkages in the middle of (1,4)- and (1,6)-α-D-glucosidic polymers (starch and glycogen) while glucoamylases can hydrolyze both (1,4)- and (1,6)-α-D-glucosidic linkages at non-reducing ends of the glucosidic polymers. Thus, attempts have been made to include exogenous α-amylases in feed for purposes of increasing rumen starch digestibility (DiLorenzo et al., Livestock Science 137 (2011) 178-184), but the results suggested that supplementation with bacterial exogenous α-amylase at 600 KNU/kg dietary DM was unable to affect nutrient digestibility or performance by feedlot steers.

Relatively recently, due to improvements in high throughput sequencing, detailed analyses of the metagenomics of the rumen microbiome have been achieved (Hess et al., Science 2011, 331, 463-467). These studies indicate that rumen microbes already secrete numerous cellulases, hemicellulases, amylases, phytases, and proteases. Regarding rumen-produced proteases, it has been suggested that these can be detrimental to feed enzymes introduced to ruminant feed (Brock et al., Appl. Environ Microbiol. 1982, 44, 561-569). What is needed, therefore, is a way to stably protect exogenously added feed enzymes during transit through the upper digestive system (particularly the rumen and abomasum) of ruminant animals, whereby they are released into the small intestine to digest nutrients, for example polysaccharides such as starch, that have also completed passage through the rumen and the abomasum.

The subject matter disclosed herein addresses these needs and provides additional benefits as well.

### SUMMARY

Provided herein, inter alia, are feed and/or feed additive compositions comprising one or more active agents (such as an enzyme). The active agent (such as an enzyme) is part of a core that also contains a carrier with at least one proton acceptor or proton consumer or proton trapper. The core is coated with a fat-coating substance to form a granule and the fat-coating substance decreases the degree of degradation of the granule (or a feed or feed additive containing the granule) within the rumen and abomasum environment of ruminant animals. Also provided herein are methods for making and using the active agents (such as an enzyme)-containing granules, feed, and feed additive compositions disclosed herein.

Accordingly, in some aspects, provided herein is a granulated feed additive composition comprising an enzyme coated with one or more fats, wherein the enzyme maintains at least about 50% residual activity after being coated. In some embodiments, the granules are from about 100 μm, 200 μm, 300 μm, 400 μm, 500 μm, or 580 μm to about 1466 μm diameter in size. In some embodiments of any of the embodiments described herein, at least about 25% of the granules have a diameter greater than about 100 μm, 200 μm, 300 μm, 400 μm, 500 μm, or 580 μm and less than 1% of the granules have a diameter greater than about 1466 μm. In some embodiments of any of the embodiments described herein, a) about 90% of the granules have a diameter below about 1225 μm; b) about 50% granules have a diameter below about 846 μm; and/or c) about 10% granules are below about 356 μm in diameter. In some embodiments of any of the embodiments described herein, the enzyme maintains at least about 55%, about 60%, about 65%, about 70%, about 75%, about 80%, about 85%, about 90%, about 95%, or about 100% residual activity after being coated. In some embodiments, the enzyme maintains at least about 60%, about 65%, about 70%, about 75%, about 80%, about 85%, about 90%, about 95%, or about 100% residual activity in 0.1M MES—NaOH buffer at pH 6.0 and 40° C. with a shaking speed of 215 rpm for 1, 2, 3, 4, or 5 hours. In some embodiments of any of the embodiments described herein, the composition has a moisture content of about 5% (w/w) or less. In some embodiments of any of the embodiments described herein, the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof. In some embodiments, the fat is an animal fat or oil and/or a plant fat or oil. In some embodiments, the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil. In some embodiments, the plant fat or oil is selected from the group consisting of fully hardened palm oil, fully hardened rapeseed oil, fully hardened cottonseed oil and fully hardened soybean oil. In some embodiments of any of the embodiments described herein, the plant fat or oil is palm oil or fully hardened palm oil. In some embodiments of any of the embodiments described herein, the fat has a melting point of about 40° C. to about 80° C. In some embodiments of any of the embodiments described herein, the enzyme is one or more selected from the group consisting of acetyl esterases, aminopeptidases, amylases, arabinases, arabinofuranosidases, carboxypeptidases, catalases, cellulases, chitinases, chymosin, lysozymes, cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, mannanase, and combinations thereof. In some embodiments, the enzyme is a glucoamylase. In some embodiments, the glucoamylase is derived from a filamentous fungus, optionally comprising the polypeptide of SEQ ID NO:1, SEQ ID NO:2, SEQ ID NO:3, SEQ ID NO:4, or SEQ ID NO:5. In some embodiments, the enzyme is a combination selected from i) an endoamylase and an exoamylase; ii) an endoamylase (mainly alpha amylases), especially those from Bacillus licheniformis, Geobacillus stearothermophilus, Aspergillus kawachii, A. clavatus, and variants thereof, an exoamylase (mainly glucoamylases), a protease and a xylanase; or iii) an endoamylase, an exoamylase, a protease, a xylanase and a beta-glucanase. In some embodiments of any of the embodiments described herein, the composition further comprises an essential oil. In some embodiments, the essential oil comprises thymol and/or cinnamaldehyde. In some embodiments of any of the embodiments described herein, the composition further comprises betaine or a feed acceptable salt or hydrate thereof. In some embodiments of any of the embodiments described herein, the composition further comprises at least one direct fed microbial (DFM). In some embodiments, the DFM is a viable bacterium. In some embodiments of any of the embodiments described herein, the composition comprises at least three DFMs. In some embodiments, the DFMs comprise Bacillus strain 2084 Accession No. NRRL B-50013, Bacillus strain LSSAO1 Accession No. NRRL B-50104 and Bacillus strain 15A-P4 ATCC Accession No. PTA-6507. In some embodiments of any of the embodiments described herein, the DFM is present in the feed additive composition in a range from about 2.5×103 CFU to about 6.7×106 CFU. In some embodiments of any of the embodiments described herein, the composition further comprises one or more of a phage, a prebiotic, and/or a carbohydrate immune stimulant. In some embodiments of any of the embodiments described herein, the granules have a density of about 0.6 to 1.3 g/ml. In some embodiments, the granules have a density of about 0.63 g/ml.

In another aspect, provided herein is a coated enzyme granule produced by a) mixing the enzyme with a molten coating material comprising a fat; and b) granulating by rapidly decreasing the temperature of the mixture, wherein the enzyme maintains at least about 50% residual activity after being cooled. In some embodiments, the temperature is decreased by one or more of spray cooling, spray chilling and/or spray freezing. In some embodiments, the temperature is decreased by spray cooling at a temperature of about 15-40° C. In some embodiments, the temperature is decreased by spray chilling at temperature of about 0-15° C. In some embodiments, the temperature is decreased by spray freezing at temperature of less than 0° C. In some embodiments, the temperature is decreased by atomization into a stream of gas having a temperature lower than the melting point of the fat. In some embodiments of any of the embodiments described herein, the granule is from about 100 μm, 200 μm, 300 μm, 400 μm, 500 μm, or 580 μm to about 1466 μm diameter in size. In some embodiments of any of the embodiments described herein, at least about 25% of the granules have a diameter greater than about 100 μm, 200 μm, 300 μm, 400 μm, 500 μm, or 580 μm and less than 1% of the granules have a diameter greater than about 1466 μm. In some embodiments of any of the embodiments described herein, a) about 90% of the granules have a diameter below about 1225 μm; b) about 50% granules have a diameter below about 846 μm; and/or c) about 10% granules are below about 356 μm in diameter. In some embodiments of any of the embodiments described herein, the enzyme maintains at least about 55%, about 60%, about 65%, about 70%, about 75%, about 80%, about 85%, about 90%, about 95%, or about 100% residual activity after being coated. In some embodiments, the enzyme maintains at least about 60%, about 65%, about 70%, about 75%, about 80%, about 85%, about 90%, about 95%, or about 100% residual activity in 0.1M MES—NaOH buffer at pH 6.0 and 40° C. with a shaking speed of 215 rpm for 1, 2, 3, 4, or 5 hours. In some embodiments of any of the embodiments described herein, the granule has a moisture content of about 5% (w/w) or less. In some embodiments of any of the embodiments described herein, the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof. In some embodiments, the fat is an animal fat or oil and/or a plant fat or oil. In some embodiments, the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil. In some embodiments, the plant fat or oil is selected from the group consisting of fully hardened palm oil, fully hardened rapeseed oil, fully hardened cottonseed oil and fully hardened soybean oil. In some embodiments of any of the embodiments described herein, the plant fat or oil is palm oil or fully hardened palm oil. In some embodiments of any of the embodiments described herein, the fat has a melting point of about 40° C. to about 80° C. In some embodiments of any of the embodiments described herein, the enzyme is one or more selected from the group consisting of acetyl esterases, aminopeptidases, amylases, arabinases, arabinofuranosidases, carboxypeptidases, catalases, cellulases, chitinases, lysozymes, chymosin, cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, mannanase, and combinations thereof. In some embodiments, the enzyme is a glucoamylase. In some embodiments, the glucoamylase is derived from a filamentous fungus, optionally comprising the polypeptide of SEQ ID NO:1, SEQ ID NO:2, SEQ ID NO:3, SEQ ID NO:4, or SEQ ID NO:5. In some embodiments, the enzyme is a combination selected from i) an endoamylase and an exoamylase; ii) an endoamylase, especially those from Bacillus licheniformis, Geobacillus stearothermophilus, Aspergillus kawachii, A. clavatus, and variants thereof, an exoamylase, a protease and a xylanase; or iii) an endoamylase, an exoamylase, a protease, a xylanase and a beta-glucanase. In some embodiments of any of the embodiments described herein the enzyme is mixed with the molten coating material at a temperature less than about 80° C. In some embodiments of any of the embodiments described herein, the granules have a density of about 0.6 to 1.3 g/ml. In some embodiments, the granules have a density of about 0.63 g/ml. In some embodiments of any of the embodiments described herein, the enzyme is mixed with a molten coating material for at least about two hours. In some embodiments, the enzyme is mixed with a molten coating material for at least about 1.5 hours.

In further aspects, provided herein is a feed comprising any of the feed additive compositions disclosed herein or any of the fat-coated granules (such as fat-coated enzyme granules) disclosed herein. In some embodiments, the feed further comprises an animal protein, a vegetable protein, corn, soybean meal, corn dried distillers grains with solubles (cDDGS), wheat, wheat proteins, gluten, wheat by products, wheat bran, wheat dried distillers grains with solubles (wDDGS), corn by products including corn gluten meal, barley, oat, rye, triticale, full fat soy, animal by-product meals, an alcohol-soluble protein, a zein, a maize zein maize, a kafirin, a protein from oil seeds, or a combination thereof. In some embodiments, the animal protein or vegetable protein is selected from the group consisting of one or more of a gliadin or an immunogenic fragment of a gliadin, a beta-casein, a beta-lactoglobulin, glycinin, beta-conglycinin, cruciferin, napin, hordeins, keratins, feather or hair meals, collagen, whey protein, fish protein, fish meals, meat protein, egg protein, soy protein and grain protein. In some embodiments, the protein from oil seeds is selected from the group consisting of soybean seed proteins, sun flower seed proteins, rapeseed proteins, canola seed proteins and combinations thereof.

In yet other aspects, provided herein is a premix comprising a) i) any of the feed additive compositions disclosed herein; or ii) any of the fat-coated granules (such as fat-coated enzyme granules) disclosed herein; and b) at least one mineral and/or at least one vitamin.

In still further aspects, provided herein is a kit comprising a) i) any of the feed additive compositions disclosed herein; ii) any of the fat-coated granules (such as fat-coated enzyme granules) disclosed herein; iii) any of the feeds disclosed herein; and/or iv) any of the premix compositions disclosed herein; and b) instructions for formulating and/or administrating to a subject.

In another aspect, provided herein is a method for improving the performance of a subject comprising administering to the subject an effective amount any of the feed or feed additive compositions disclosed herein, wherein improving the performance of a subject comprises of one or more of (a) improved feed conversion ratio (FCR); (b) improved weight gain; (c) improved feed efficiency; (d) improved carcass quality; and/or (e) improved milk production compared to the performance of a subject that has not been administered the feed additive composition. In still another aspect, provided herein is a method for one or more of a) increasing starch digestibility; and/or b) lowering fecal starch output in a subject comprising adding an effective amount of any of the fat-coated granules (such as fat-coated enzyme granules) disclosed herein as a feed additive to feed for a subject, wherein said granule maintains at least about 60% residual activity in 0.1M MES—NaOH buffer at pH 6.0 and 40° C. with a shaking speed of 215 rpm for 1, 2, 3, 4, or 5 hours. In some embodiments of any of the embodiments described herein, the subject is a ruminant. In some embodiments, the ruminant is selected from the group consisting of cattle, goats, sheep, giraffes, deer, gazelles, and antelopes. In some embodiments, the cattle are beef cattle or dairy cattle. In some embodiments of any of the embodiments described herein, the feed further comprises an animal protein, a vegetable protein, corn, soybean meal, corn dried distillers grains with solubles (cDDGS), wheat, wheat proteins, gluten, wheat by products, wheat bran, wheat dried distillers grains with solubles (wDDGS), corn by products including corn gluten meal, barley, oat, rye, triticale, full fat soy, animal by-product meals, an alcohol-soluble protein, a zein, a maize zein maize, a kafirin, a protein from oil seeds, or a combination thereof.

In other aspects, provided herein is a method for manufacturing a coated enzyme granule comprising a) mixing the enzyme with a molten coating material comprising a fat; and b) granulating by rapidly decreasing the temperature of the mixture, wherein the enzyme maintains at least about 50% residual activity after being cooled. In some embodiments, the temperature is decreased by one or more of spray cooling, spray chilling and/or spray freezing. In some embodiments, the temperature is decreased by spray cooling at a temperature of about 15-40° C. In some embodiments, the temperature is decreased by spray chilling at temperature of about 0-15° C. In some embodiments, the temperature is decreased by spray freezing at temperature of less than 0° C. In some embodiments, the temperature is decreased by atomization into a stream of gas having a temperature lower than the melting point of the fat. In some embodiments of any of the embodiments described herein, the granules are from about 100 μm, 200 μm, 300 μm, 400 μm, 500 μm, or 580 μm to about 1466 μm diameter in size. In some embodiments, at least about 25% of the granules have a diameter greater than about 100 μm, 200 μm, 300 μm, 400 μm, 500 μm, or 580 μm and less than 1% of the granules have a diameter greater than about 1466 μm. In some embodiments of any of the embodiments described herein, a) about 90% of the granules have a diameter below about 1225 μm; b) about 50% granules have a diameter below about 846 μm; and/or c) about 10% granules are below about 356 μm in diameter. In some embodiments of any of the embodiments described herein, the enzyme maintains at least about 55%, about 60%, about 65%, about 70%, about 75%, about 80%, about 85%, about 90%, about 95%, or about 100% residual activity after being coated. In some embodiments, the enzyme maintains at least about 60%, about 65%, about 70%, about 75%, about 80%, about 85%, about 90%, about 95%, or about 100% residual activity in 0.1M MES—NaOH buffer at pH 6.0 and 40° C. with a shaking speed of 215 rpm for 1, 2, 3, 4, or 5 hours. In some embodiments of any of the embodiments described herein, the granule has a moisture content of about 5% (w/w) or less. In some embodiments of any of the embodiments described herein, the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof. In some embodiments, the fat is an animal fat or oil and/or a plant fat or oil. In some embodiments, the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil. In some embodiments, the plant fat or oil is selected from the group consisting of fully hardened palm oil, fully hardened rapeseed oil, fully hardened cottonseed oil and fully hardened soybean oil. In some embodiments of any of the embodiments described herein, the plant fat or oil is palm oil or fully hardened palm oil. In some embodiments of any of the embodiments described herein, the fat has a melting point of about 40° C. to about 80° C. In some embodiments of any of the embodiments described herein, the enzyme is one or more selected from the group consisting of acetyl esterases, aminopeptidases, amylases, arabinases, arabinofuranosidases, carboxypeptidases, catalases, cellulases, chitinases, chymosin, lysozymes, cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, mannanase, and combinations thereof. In some embodiments, the enzyme is a glucoamylase. In some embodiments, the glucoamylase is derived from a filamentous fungus, optionally comprising the polypeptide of SEQ ID NO:1, SEQ ID NO:2, SEQ ID NO:3, SEQ ID NO:4, or SEQ ID NO:5. In some embodiments, the enzyme is a combination selected from i) an endoamylase and an exoamylase; ii) an endoamylase, especially those from Bacillus licheniformis, Geobacillus stearothermophilus, Aspergillus kawachii, A. clavatus, and variants thereof, an exoamylase, a protease and a xylanase; or iii) an endoamylase, an exoamylase, a protease, a xylanase and a beta-glucanase. In some embodiments of any of the embodiments described herein, the method further comprises coating the enzyme granule with an essential oil. In some embodiments, the essential oil comprises thymol and/or cinnamaldehyde. In some embodiments of any of the embodiments described herein, the method further comprises coating the enzyme granule with betaine or a feed acceptable salt or hydrate thereof. In some embodiments of any of the embodiments described herein the enzyme is mixed with the molten coating material at a temperature less than about 80° C. In some embodiments of any of the embodiments described herein, the granules have a density of about 0.6 to 1.3 g/ml. In some embodiments, the granules have a density of about 0.63 g/ml. In some embodiments of any of the embodiments described herein, the enzyme is mixed with a molten coating material for at least about two hours. In some embodiments, the enzyme is mixed with a molten coating material for at least about 1.5 hours.

In other aspects, provided herein is a granule comprising (a) a core comprising (i) an active agent (such as an enzyme); and (ii) a carrier comprising at least one proton acceptor or proton consumer or proton trapper; and (b) one or more layers of one or more fats, wherein the core is coated by the one or more fats and wherein the enzyme maintains at least about 50% residual activity after being coated. In some embodiments, the granule is from about 100 μm to about 1500 μm diameter in size. In some embodiments of any of the embodiments described herein, the granule has a particle density from about 0.6 g/mL to about 1.2 g/mL. In some embodiments of any of the embodiments described herein, the enzyme maintains at least about 55%, about 60%, about 65%, about 70%, about 75%, about 80%, about 85%, about 90%, about 95%, or about 100% residual activity after being coated. In some embodiments of any of the embodiments described herein, the composition has a moisture content of about 5% (w/w) or less. In some embodiments of any of the embodiments described herein, the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof. In some embodiments, the fat is an animal fat or oil and/or a plant fat or oil. In some embodiments, the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil. In some embodiments, the plant fat or oil is selected from the group consisting of fully hardened palm oil, fully hardened rapeseed oil, fully hardened cottonseed oil and fully hardened soybean oil. In some embodiments of any of the embodiments described herein, the plant fat or oil is palm oil or fully hardened palm oil. In some embodiments of any of the embodiments described herein, the fat has a melting point of about 40° C. to about 80° C. In some embodiments of any of the embodiments described herein, the enzyme is one or more selected from the group consisting of acetyl esterases, aminopeptidases, amylases, arabinases, arabinofuranosidases, carboxypeptidases, catalases, cellulases, chitinases, chymosin, lysozymes, cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, mannanase, and combinations thereof. In some embodiments, the enzyme is a glucoamylase. In some embodiments, the glucoamylase is derived from a filamentous fungus, optionally comprising the polypeptide of SEQ ID NO:1, SEQ ID NO:2, SEQ ID NO:3, SEQ ID NO:4, or SEQ ID NO:5. In some embodiments of any of the embodiments described herein, the carrier comprises sodium carbonate (Na₂CO₃), sodium bicarbonate (NaHCO₃), calcium carbonate (CaCO₃), magnesium carbonate (MgCO₃), sodium acetate (CH₃COONa), and/or calcium acetate (Ca(C₂H₃O₂)₂). In some embodiments, the carrier comprises limestone. In some embodiments of any of the embodiments described herein, the granule comprises from about 30% to about 70% (w/w) fat content. In some embodiments of any of the embodiments described herein, the granule comprises from about 10% to about 30% (w/w) carrier content. In some embodiments of any of the embodiments described herein, the granule comprises from about 10% to about 40% (w/w) enzyme content.

In another aspect, provided herein is a feed additive composition comprising any of the granules disclosed herein. In some embodiments, the composition further comprises an essential oil. In some embodiments, the essential oil comprises thymol and/or cinnamaldehyde. In some embodiments of any of the embodiments described herein, the composition further comprises betaine or a feed acceptable salt or hydrate thereof. In some embodiments of any of the embodiments described herein, the composition further comprises at least one direct fed microbial (DFM). In some embodiments, the DFM is a viable bacterium. In some embodiments of any of the embodiments described herein, the composition comprises at least three DFMs. In some embodiments, the DFMs comprise Bacillus strain 2084 Accession No. NRRL B-50013, Bacillus strain LSSAO1 Accession No. NRRL B-50104 and Bacillus strain 15A-P4 ATCC Accession No. PTA-6507. In some embodiments of any of the embodiments described herein, the DFM is present in the feed additive composition in a range from about 2.5×10³ CFU to about 6.7×10⁶ CFU. In some embodiments of any of the embodiments described herein, the composition further comprises one or more of a phage, a prebiotic, and/or a carbohydrate immune stimulant.

In another aspect, provided herein is a feed comprising any of the granules disclosed herein or any of the feed additive compositions disclosed herein. In some embodiments, the feed further comprises an animal protein, a vegetable protein, corn, soybean meal, corn dried distillers grains with solubles (cDDGS), wheat, wheat proteins, gluten, wheat by products, wheat bran, wheat dried distillers grains with solubles (wDDGS), corn by products including corn gluten meal, barley, oat, rye, triticale, full fat soy, animal by-product meals, an alcohol-soluble protein, a zein, a maize zein maize, a kafirin, rice, paddy rice, extruded paddy rice, a protein from oil seeds, or a combination thereof. In some embodiments, the animal protein or vegetable protein is selected from the group consisting of one or more of a gliadin or an immunogenic fragment of a gliadin, a beta-casein, a beta-lactoglobulin, glycinin, beta-conglycinin, cruciferin, napin, hordeins, keratins, feather or hair meals, collagen, whey protein, fish protein, fish meals, meat protein, egg protein, soy protein and grain protein. In some embodiments, the protein from oil seeds is selected from the group consisting of soybean seed proteins, sun flower seed proteins, rapeseed proteins, canola seed proteins and combinations thereof.

In another aspect, provided herein is a premix comprising a) i) any of the d granules disclosed herein; ii) or any of the feed additive compositions disclosed herein; and b) at least one mineral and/or at least one vitamin.

In yet additional aspects, provided herein is a kit comprising a) i) any of the granules disclosed herein; ii) any of the feed additive compositions disclosed herein; iii) any of the feeds disclosed herein; and/or iv) any of the premixes any of the feeds disclosed herein; and b) instructions for formulating and/or administrating to a subject.

In another aspect, provided herein is a method for improving the performance of a subject comprising administering to the subject an effective amount any of the feed additive compositions disclosed herein or any of the feeds disclosed herein, wherein improving the performance of a subject comprises of one or more of (a) improved feed conversion ratio (FCR); (b) improved weight gain; (c) improved feed efficiency; (d) improved carcass quality; and/or (e) improved milk production compared to the performance of a subject that has not been administered the feed additive composition.

In further aspects, provided herein is a method for one or more of a) increasing starch digestibility; and/or b) lowering fecal starch output; and/or c) preventing a decrease in the pH in the lower gastrointestinal tract in a subject comprising adding an effective amount of a feed additive composition comprising any of the granules disclosed herein to a feed for administration to a subject, wherein the subject exhibits one or more of increased starch digestibility and/or lowered fecal starch output compared to a subject that has not been administered the feed additive composition. In some embodiments of any of the embodiments described herein, the subject is a ruminant. In some embodiments, the ruminant is selected from the group consisting of cattle, goats, sheep, giraffes, deer, gazelles, and antelopes. In some embodiments, the cattle are beef cattle or dairy cattle. In some embodiments of any of the embodiments described herein, the feed further comprises an animal protein, a vegetable protein, corn, soybean meal, corn dried distillers grains with solubles (cDDGS), wheat, wheat proteins, gluten, wheat by products, wheat bran, wheat dried distillers grains with solubles (wDDGS), corn by products including corn gluten meal, barley, oat, rye, triticale, full fat soy, animal by-product meals, an alcohol-soluble protein, a zein, a maize zein maize, a kafirin, rice, paddy rice, extruded paddy rice, a protein from oil seeds, or a combination thereof.

In another aspect, provided herein is a method for manufacturing a coated enzyme granule comprising coating a core comprising (i) an enzyme; and (ii) a carrier comprising at least one proton acceptor with one or more layers of one or more fats. In some embodiments, the core is coated by a process selected from the group consisting of spray cooling, spray chilling, spray freezing, and hot melt fluid bed coating. In some embodiments, the granule is from about 100 μm to about 1500 μm diameter in size. In some embodiments of any of the embodiments described herein, the granule has a particle density from about 0.6 g/mL to about 1.2 g/mL. In some embodiments of any of the embodiments described herein, the enzyme maintains at least about 55%, about 60%, about 65%, about 70%, about 75%, about 80%, about 85%, about 90%, about 95%, or about 100% residual activity after being coated. In some embodiments of any of the embodiments described herein, the composition has a moisture content of about 5% (w/w) or less. In some embodiments of any of the embodiments described herein, the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof. In some embodiments, the fat is an animal fat or oil and/or a plant fat or oil. In some embodiments, the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil. In some embodiments, the plant fat or oil is selected from the group consisting of fully hardened palm oil, fully hardened rapeseed oil, fully hardened cottonseed oil and fully hardened soybean oil. In some embodiments of any of the embodiments described herein, the plant fat or oil is palm oil or fully hardened palm oil. In some embodiments of any of the embodiments described herein, the fat has a melting point of about 40° C. to about 80° C. In some embodiments of any of the embodiments described herein, the enzyme is one or more selected from the group consisting of acetyl esterases, aminopeptidases, amylases, arabinases, arabinofuranosidases, carboxypeptidases, catalases, cellulases, chitinases, chymosin, lysozymes , cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, marmanase, and combinations thereof. In some embodiments, the enzyme is a glucoamylase. In some embodiments, the glucoamylase is derived from a filamentous fungus, optionally comprising the polypeptide of SEQ ID NO:1, SEQ ID NO:2, SEQ ID NO:3, SEQ ID NO:4, or SEQ ID NO:5. In some embodiments of any of the embodiments described herein, the carrier comprises sodium carbonate (Na₂CO₃), sodium bicarbonate (NaHCO₃), calcium carbonate (CaCO₃) magnesium carbonate (MgCO₃), sodium acetate (CH₃COONa), and/or calcium acetate (Ca(C₂H₃O₂)₂). In some embodiments, the carrier comprises limestone. In some embodiments of any of the embodiments described herein, the granule comprises from about 30% to about 70% (w/w) fat content. In some embodiments of any of the embodiments described herein, the granule comprises from about 10% to about 30% (w/w) carrier content. In some embodiments of any of the embodiments described herein, the granule comprises from about 10% to about 40% (w/w) enzyme content. In some embodiments of any of the embodiments described herein, the method further comprises coating the enzyme granule with an essential oil. In some embodiments, the essential oil comprises thymol and/or cinnamaldehyde. In some embodiments of any of the embodiments described herein, the method further comprises coating the enzyme granule with betaine or a feed acceptable salt or hydrate thereof.

Each of the aspects and embodiments described herein are capable of being used together, unless excluded either explicitly or clearly from the context of the embodiment or aspect.

Throughout this specification, various patents, patent applications and other types of publications (e.g., journal articles, electronic database entries, etc.) are referenced. The disclosure of all patents, patent applications, and other publications cited herein are hereby incorporated by reference in their entirety for all purposes.

### BRIEF DESCRIPTION OF THE DRAWINGS

FIG. 1A is a photograph depicting the morphology of a fat coated enzyme. FIG. 1B is a graph depicting the sphericity of a fat coated enzyme.

FIG. 2A, FIG. 2B, and FIG. 2C depict representative light microscope photographs for three batches of fat-coated enzyme granules: 60% Spray-dried TrGA enzyme on limestone with 40% hardened palm oil (FIG. 2A), 50% Spray-dried TrGA enzyme on limestone with 50% hardened palm oil (FIG. 2B), 40% Spray-dried TrGA enzymes on limestone with 60% hardened palm oil (FIG. 2C).

FIG. 3 is a graphic depiction of a non-limiting representative granule composition with limestone inside an enzyme core surrounded by a fat layer, whereby, without being bound to theory, a proton consumption reaction can take place preventing the lowering of pH.

FIG. 4 is a graph depicting fecal pH as affected by increasing starch in milk replacer and presence or absence of fat protected enzymes of sample Fla0215 (AnGA) and sample Dam001 (TrGA).

FIG. 5 is a graph depicting distribution of fecal pH in calves receiving milk replacer with 17.5% starch with and without fat coated enzyme inclusion (P<0.05).

### DETAILED DESCRIPTION

A ruminant is a mammal of the order Artiodactyla that digests plant-based food by initially softening it within the animal's first stomach chamber, then regurgitating the semi-digested mass, now known as cud, and chewing it again. The process of rechewing the cud to further break down plant matter and stimulate digestion is called “ruminating” or “rumination.”

Ruminants have a stomach with four chambers, namely the rumen, reticulum, omasum and abomasum. In the first two chambers, the rumen and the reticulum, food is mixed with saliva and separates into layers of solid and liquid material. Solids clump together to form the cud, or bolus. The cud is then regurgitated, chewed slowly to completely mix it with saliva, which further breaks down fibers. Fiber, especially cellulose, is broken down into glucose in these chambers by the enzymes produced by commensal bacteria, protozoa and fungi (such as cellulases, hemicellulases, amylases, phytases, and proteases). The broken-down fiber, which is now in the liquid part of the contents, then passes through the rumen and reticulum into the next stomach chamber, the omasum, where water is removed. The food in the abomasum is digested much like it would be in the human stomach. The abomasum has a pH of around 2.0 and therefore possesses an environment capable of denaturing most, if not all, polypeptides. The processed food is finally sent to the small intestine, where the absorption of the nutrients occurs.

In ruminant nutrition, it is a challenge to bypass the rumen successfully to allow the feed or feed additives to reach the preferred site, which is often lower down the GI tract, e.g. the small intestine. Often the feed or feed additives used are degraded in the rumen environment (due to the presence of proteases produced by commensal microorganisms) or in the abomasum (due to the highly acidic environment) which results in either loss of form or activity of the feed or feed additive. Therefore, larger quantities of feed and feed additives are often used to compensate, thus adding to the costs of ruminant nutrition.

Despite these challenges, as disclosed herein, the inventors have surprisingly found that coating enzymes in fat followed by immediate cooling resulted in enzyme granules that retained more than 50% of residual enzymatic activity, and in some cases, more than 80% of residual activity despite having been exposed to potentially protein-degradative molten fat for up to 2 hours. It was further surprising that the fat-coated enzyme granules maintained up to 50% of residual activity up to 5 h after having been suspended in a fluid that mimics the rumen environment.

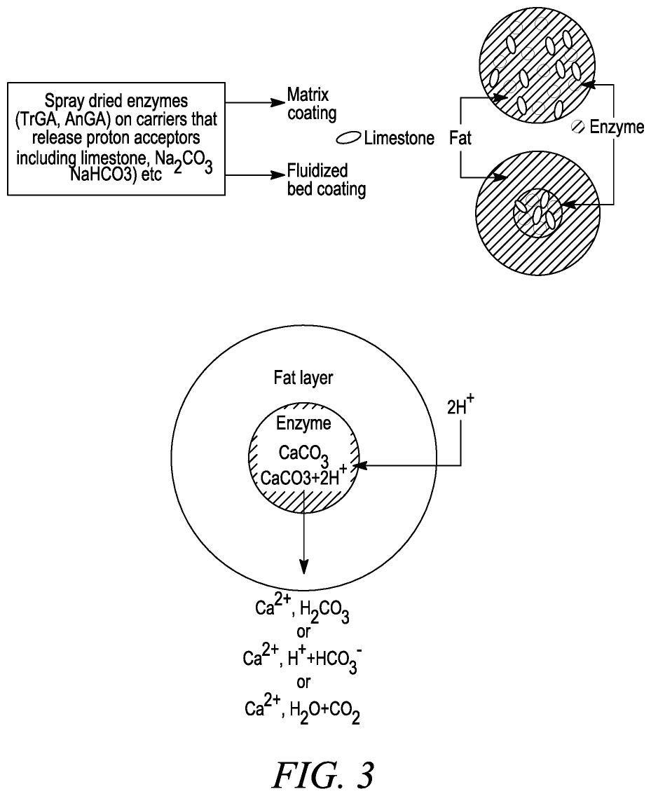

The inventors have further discovered that fat-coated granules with cores comprising one or more active agent(s) (such as one or more enzyme(s)) and a carrier capable of acting as a proton acceptor or proton consumer or proton trapper are able to transit the rumen and abomasum in a highly efficient manner to deliver active agents (such as an enzyme) to the small intestine of ruminant animals, where it assists in the digestion of polysaccharides. Specifically, without being bound to theory, it is believed that the fat coating protects the active agents (such as an enzyme) in the harsh enzymatic environment of the rumen and in the highly acidic protein-degradative environment of the abomasum (see FIG. 3).

Moreover, again without being bound to theory, it is believed that the proton acceptor-containing carrier of the granule core serves to increase the efficiency and effectiveness of active agent (such as an enzyme) delivery to the small intestine by 1) raising the pH inside the granule and/or around the granule within the abomasum by neutralizing any protons that diffuse inside the granule (thereby protecting the active agent (such as an enzyme) from acidic degradation); and 2) increasing the particle density, which is believed to shorten transit time through the upper gastrointestinal tract thereby lessening the time the granule is exposed to the highly degradative rumen environment,

Accordingly, for the first time, the inventors have discovered a means to ensure effective delivery of functional feed and feed additive enzymes to the small intestine of ruminant animals while avoiding substantial degradation in the rumen and abomasum.

### I. Definitions

The terms “animal” and “subject” are used interchangeably herein and refer to any organism belonging to the kingdom Animalia and includes, without limitation, mammals (excluding humans), non-human animals, domestic animals, livestock, farm animals, zoo animals, breeding stock and the like. For example, there can be mentioned all non-ruminant and ruminant animals. In an embodiment, the animal is a non-ruminant, i.e., mono-gastric animal. Examples of mono-gastric animals include, but are not limited to, pigs and swine, such as piglets, growing pigs, sows; poultry such as turkeys, ducks, chicken, broiler chicks, layers; fish such as salmon, trout, tilapia, catfish and carps; and crustaceans such as shrimps and prawns. In a further embodiment, the animal is a ruminant animal.

As used herein the term “ruminant” refers to the members of the Ruminantia and Tylopoda suborders. In one embodiment, the ruminant animal can be selected from the members of the Antilocapridae, Bovidae, Cervidae, Giraffidae, Moschidae, Tragulidae families. In another embodiment, the ruminant animal can be a cow, goat, sheep, giraffe, bison, yak, water buffalo, deer, camel, alpaca, llama, wildebeest, antelope, pronghorn or nilgai. In another embodiment, the ruminant is selected from cattle (including beef and dairy cattle), sheep, goats and buffalo.

As used herein, the term “rumen environment” refers to the conditions within the rumen. In general, the rumen has a temperature of about 39° C. and a pH in the range of 5 to 7 and is colonized by microbes. As the environment inside a rumen is anaerobic, most microbial species are obligate or facultative anaerobes that can decompose complex plant material, such as cellulose, hemicellulose, starch, and proteins. The hydrolysis of cellulose results in sugars, which are further fermented to products such as acetate, lactate, propionate, butyrate, carbon dioxide and methane. In one embodiment, degradation of exogenously fed enzymes is primarily due to the action of rumen microbes present in the rumen environment. In some embodiments, reaction conditions in 0.1M MES buffer at pH 6.0 simulates the rumen environment. In other embodiments, “rumen environment” can refer generally to the entire upper gastrointestinal tract of ruminant animals which includes the rumen, reticulum, omasum and abomasum.

As used herein, the term “granule” refers to a particle which contains a core, an active agent (such as one or more enzymes), and at least one coating layer comprising a fat.

As used herein, the term “core” refers to the inner nucleus of a granule, comprising an active agent (such as an enzyme) and a proton acceptor-containing carrier. The cores of the present teachings may be produced by a variety of fabrication techniques including: rotary atomization, wet granulation, dry granulation, spray drying, disc granulation, extrusion, pan coating, spheronization, drum granulation, fluid-bed agglomeration, high-shear granulation, fluid-bed spray coating, crystallization, precipitation, emulsion gelation, spinning disc atomization and other casting approaches, and prill processes. Such processes are known in the art and are described in U.S. Pat. Nos. 4,689,297 and 5,324,649 (fluid bed processing); EP656058B1 and U.S. Pat. No. 5,739,091 (extrusion process); U.S. Pat. No. 6,248,706 (granulation, high-shear); and EP804532B1 and U.S. Pat. No. 6,534,466 (combination processes utilizing a fluid bed core and mixer coating).

The term, “carrier” as used herein means an inert, organic or inorganic material, with which an active ingredient (such as an enzyme) is mixed or formulated to form a core and increase the overall particle density of the fat-coated granule.

“Proton acceptor,” “proton consumer,” and “proton trapper,” as used herein, all refer to any chemical reaction or ionic species capable of binding to and neutralizing a proton. Under the Broensted-Lowry definition, a base acceptor is a negatively charged ion that will react with, or accept, a positively charged hydrogen ion. Since a hydrogen ion is a proton, the base is called a proton acceptor, consumer, or trapper. In some non-limiting embodiments, the proton acceptor is calcium carbonate-containing limestone.

As used herein, the term “coated” or “coating” may refer to covering the surface of a feed or feed additive or a granule core with a coating substance (such as a fat, for example a plant or animal-derived fat). In some embodiments, substantially all of the surface area of the feed or feed additive or granule core is coated. In other embodiments, all the surface area of hydro-soluble component(s) of the feed or feed additive or granule core is coated. Moreover, in still other embodiments, all of the surface area of the feed or feed additive or granule core is coated. In alternative embodiments, the term “coated” may refer to covering, encapsulation, suspension or entrapment of the feed or feed additive or granule core with/within the coating substance (such as a fat, for example a plant or animal-derived fat). Granules can be coated using any means known in the art including, without limitation, spray-crystallization techniques such as spray-cooling, spray-chilling, and spray freezing as well as methods such as hot melt fluid bed coating.

The terms “coating layer” and “layer” are used interchangeably herein. The first coating layer generally encapsulates the core in order to form a substantially continuous layer so that the core surface has few or no uncoated areas. Subsequent coating layers can encapsulate the growing granule to form one or more additional substantially continuous layer(s). The materials (e.g. the active agents and components detailed herein) used in the granule and/or multi-layered granule are suitable for the use in foods and/or animal feeds, and accordingly can be food grade or feed grade

The term “hardened fat” or “hydrogenated fat” is fat that has been exposed to a hydrogenation process (Ullmann's Encyclopedia of Industrial Chemistry, Sixth Edition, Fats and Fatty Oils, 4.3 and 8). Typically, the fat is subjected to catalytic hydrogenation in the presence of a transition metal catalyst, for example, a nickel, palladium or platinum catalyst. Fully hardened fat is defined as a fat having an Iodine Value (IV) of less than 5, where the iodine value is measured by the conventional IUPAC technique (International Union of Pure and Applied Chemistry (IUPAC), Standard Method for the Analysis of Oils, Fats and Derivatives, Method 2.205).

“Residual activity,” as used herein, means the enzymatic activity of a fat-coated enzyme compared to the enzymatic activity of an uncoated enzyme under identical conditions.

As used herein, “particle density” is the volumetric mass of a solid which differs from apparent density or bulk density because the volume used does not contain pores or spaces. This value can be obtained through any means known in the art such as by placing a known weight of powder in a liquid and measuring the volume displacement with a graduated cylinder.

As used herein “apparent bulk density” or “bulk density” is the mass of a sample taken without compaction divided by volume as measured using any means known in the art, such as that established ASTM D6683-01 (Standard Test Method for Measuring Bulk Density Values of Powders and Other Bulk Solids; world wide web.astm.org/cgi-bin/resolver.cgi?D6683-01), which is incorporated herein by reference in its entirety.

The term “sequence identity” or “sequence similarity” as used herein, means that two polynucleotide sequences, a candidate sequence and a reference sequence, are identical (i.e. 100% sequence identity) or similar (i.e. on a nucleotide-by-nucleotide basis) over the length of the candidate sequence. In comparing a candidate sequence to a reference sequence, the candidate sequence may comprise additions or deletions (i.e. gaps) as compared to the reference sequence (which does not comprise additions or deletions) for optimal alignment of the two sequences. Optimal alignment of sequences for determining sequence identity may be conducted using the any number of publicly available local alignment algorithms known in the art such as ALIGN or Megalign (DNASTAR), or by inspection.

The term “percent (%) sequence identity” or “percent (%) sequence similarity,” as used herein with respect to a reference sequence is defined as the percentage of nucleotide residues in a candidate sequence that are identical to the residues in the reference polynucleotide sequence after optimal alignment of the sequences and introducing gaps, if necessary, to achieve the maximum percent sequence identity.

As used herein, the term “active agent” may be any material that is to be added to a granule to provide the intended functionality for a given use. The active agent may be a biologically viable material, a food or feed ingredient, an antimicrobial agent, an antibiotic replacement agent, a prebiotic, a probiotic, an agrochemical ingredient, such as a pesticide, fertilizer or herbicide; a pharmaceutical ingredient or a household care active ingredient, or combinations thereof. In a one embodiment, the active agent is a protein, enzyme, peptide, polypeptide, amino acid, carbohydrate, lipid or oil, vitamin, co-vitamin, hormone, or combinations thereof. Inherently thermostable active agents are encompassed by the present teachings and can exhibit enhanced thermostability in the granules. Some non-limiting active agent for food and feed applications are enzymes, peptides and polypeptides, amino acids, antimicrobials, gut health promoting agents, vitamins, and combinations thereof. Any enzyme may be used, and a nonlimiting list of enzymes include phytases, xylanases, 3-glucanases, phosphatases, proteases, amylases (alpha or beta or glucoamylases) cellulases, lipases, cutinases, oxidases, transferases, reductases, glucoamylases, hemicellulases, mannanases, esterases, isomerases, pectinases, lactases, peroxidases, laccases, other redox enzymes and mixtures thereof. The above enzyme lists are examples only and are not meant to be exclusive. Any enzyme may be used in the granules of the present invention, including wild type, recombinant and variant enzymes of bacterial, fungal, yeast, plant, insect and animal sources, and acid, neutral or alkaline enzymes. It will be recognized by those skilled in the art that the amount of enzyme used will depend, at least in part, upon the type and property of the selected enzyme and the intended use.

As used herein, “prevent,” “preventing,” “prevention” and grammatical variations thereof refers to a method of partially or completely delaying or precluding the onset or recurrence of a disorder or condition (such as necrotic enteritis) and/or one or more of its attendant symptoms or barring an animal from acquiring or reacquiring a disorder or condition or reducing an animal's risk of acquiring or reacquiring a disorder or condition or one or more of its attendant symptoms.

As used herein, the term “reducing” in relation to a particular trait, characteristic, feature, biological process, or phenomena refers to a decrease in the particular trait, characteristic, feature, biological process, or phenomena. The trait, characteristic, feature, biological process, or phenomena can be decreased by 5%, 10%, 15%, 20%, 25%, 30%, 35%, 40%, 45%, 50%, 55%, 60%, 65%, 70%, 75%, 80%, 85%, 90%, 95%, 100% or greater than 100%.

As used herein “administer” or “administering” is meant the action of introducing one or more microbial strain, an exogenous feed enzyme and/or a strain and an exogenous feed enzyme to an animal, such as by feeding or by gavage.

As used herein, “effective amount” means a quantity of fat-coated exogenous enzymes to improve one or more metrics in an animal. Improvement in one or more metrics of an animal (such as, without limitation, any of improved feed conversion ratio (FCR); improved weight gain; improved feed efficiency; improved carcass quality; and/or improved milk production) can be measured as described herein or by other methods known in the art. An effective amount can be administered to the animal by providing ad libitum access to feed containing the fat-coated exogenous enzymes. The fat-coated exogenous enzymes can also be administered in one or more doses.

As used herein, the term “feed” is used synonymously herein with “feedstuff.” Feed broadly refers to a material, liquid or solid, that is used for nourishing an animal, and for sustaining normal or accelerated growth of an animal including newborns or young and developing animals. The term includes a compound, preparation, mixture, or composition suitable for intake by an animal (such as, e.g., for poultry such as quail, ducks, turkeys, and chickens). In some embodiments, a feed or feed composition comprises a basal food composition and one or more feed additives or feed additive compositions. The term “feed additive” as used herein refers to components included for purposes of fortifying basic feed with additional components to promote feed intake, treat or prevent disease, or alter metabolism. Feed additives include pre-mixes.

As used herein, the term “feed additive” refers to a substance which is added to a feed. Feed additives may be added to feed for a number of reasons. For instance, to enhance digestibility of the feed, to supplement the nutritional value of the feed, improve the immune defense of the recipient and/or to improve the shelf life of the feed. In some embodiments, the feed additive supplements the nutritional value of the feed and/or improves the immune defense of the recipient.

A “premix,” as referred to herein, may be a composition composed of micro-ingredients such as, but not limited to, one or more of vitamins, minerals, chemical preservatives, antibiotics, fermentation products, and other essential ingredients. Premixes are usually compositions suitable for blending into commercial rations.

The term “performance” as used herein may be determined by the feed efficiency and/or weight gain of the animal and/or by the feed conversion ratio and/or by the digestibility of a nutrient in a feed (e.g., amino acid digestibility or phosphorus digestibility) and/or digestible energy or metabolizable energy in a feed and/or by nitrogen retention and/or by animals' ability to avoid the negative effects of diseases or by the immune response of the subject. Performance characteristics may include but are not limited to: body weight; weight gain; mass; body fat percentage; height; body fat distribution; growth; growth rate; milk production; mineral absorption; mineral excretion, mineral retention; bone density; bone strength; feed conversion rate (FCR); average daily feed intake (ADFI); Average daily gain (ADG) retention and/or a secretion of any one or more of copper, sodium, phosphorous, nitrogen and calcium; amino acid retention or absorption; mineralization, bone mineralization carcass yield and carcass quality.

By “improved animal performance” it is meant that there is increased feed efficiency, and/or increased weight gain and/or reduced feed conversion ratio and/or improved digestibility of nutrients or energy in a feed and/or by improved nitrogen retention and/or by improved ability to avoid the negative effects of necrotic enteritis and/or by an improved immune response in the subject resulting from the use of feed comprising the feed additive composition described herein as compared to a feed which does not comprise said feed additive composition. In some embodiments, by “improved animal performance” it is meant that there is increased feed efficiency and/or increased weight gain and/or reduced feed conversion ratio. The improvement in performance parameters may be in respect to a control in which the feed used does not comprise a fat-coated enzyme.

As used herein, the term “feed efficiency” refers to the amount of weight gain in an animal that occurs when the animal is fed ad-libitum or a specified amount of food during a period of time. By “increased feed efficiency” it is meant that the use of a feed additive composition according the present invention in feed results in an increased weight gain per unit of feed intake compared with an animal fed without said feed additive composition being present.

As used herein, “feed conversion ratio” refers to a measure of a subject's efficiency in converting feed mass into increases of a desired output and is calculated by dividing the mass of the food eaten by the output for a specified period. For example, if an animal is raised for meat (e.g., beef), the output may be the mass gained by the animal. If an animal is raised for another intended purpose (e.g., milk production), the output will be different. The term “feed conversion ratio” may be used interchangeably with the terms “feed conversion rate” or “feed conversion efficiency.” By “lower feed conversion ratio” or “improved feed conversion ratio” it is meant that the use of a feed additive composition in feed results in a lower amount of feed being required to be fed to an animal to increase the weight of the animal by a specified amount compared to the amount of feed required to increase the weight of the animal by the same amount when the feed does not comprise said feed additive composition.

As used herein, “microorganism” or “microbe” refers to a bacterium, a fungus, a virus, a protozoan, and other microbes or microscopic organisms.

The term “direct-fed microbial” (“DFM”) as used herein is source of live (viable) microorganisms that when applied in sufficient numbers can confer a benefit to the recipient thereof, i.e., a probiotic. A DFM can comprise one or more of such microorganisms such as bacterial strains. Categories of DFMs include Bacillus, Lactic Acid Bacteria and Yeasts. Thus, the term DFM encompasses one or more of the following: direct fed bacteria, direct fed yeast, direct fed yeast and combinations thereof. Bacilli are unique, gram-positive rods that form spores. These spores are very stable and can withstand environmental conditions such as heat, moisture and a range of pH. These spores germinate into active vegetative cells when ingested by an animal and can be used in meal and pelleted diets. Lactic Acid Bacteria are gram-positive cocci that produce lactic acid which are antagonistic to pathogens. Since Lactic Acid Bacteria appear to be somewhat heat-sensitive, they are not used in pelleted diets. Types of Lactic Acid Bacteria include Bifidobacterium, Lactobacillus and Streptococcus.

The terms “probiotic,” “probiotic culture,” and “DFM” are used interchangeably herein and define live microorganisms (including bacteria or yeasts, for example) which, when for example ingested or locally applied in sufficient numbers, beneficially affects the host organism, i.e. by conferring one or more demonstrable health benefits on the host organism such as a health, digestive, and/or performance benefit. Probiotics may improve the microbial balance in one or more mucosal surfaces. For example, the mucosal surface may be the intestine, the urinary tract, the respiratory tract or the skin. The term “probiotic” as used herein also encompasses live microorganisms that can stimulate the beneficial branches of the immune system and at the same time decrease the inflammatory reactions in a mucosal surface, for example the gut. Whilst there are no lower or upper limits for probiotic intake, it has been suggested that at least 10⁶-10¹², for example at least 10⁶-10¹⁰, for example 10⁸-10⁹, cfu as a daily dose will be effective to achieve the beneficial health effects in a subject.

The term “CFU” as used herein means “colony forming units” and is a measure of viable cells in which a colony represents an aggregate of cells derived from a single progenitor cell.

As used herein the term “betaine” refers to trimethylglycine. The compound is also called trimethylammonioacetate, 1-carboxy-N,N,N-trimethylmethaneaminium, inner salt and glycine betaine. It is a naturally occurring quaternary ammonium type compound having the formula

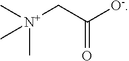

Betaine has a bipolar structure comprising a hydrophilic moiety (COO—) and a hydrophobic moiety (N+) capable of neutralizing both acid and alkaline solutions. In its pure form, betaine is a white crystalline compound that is readily soluble in water and lower alcohols. In the present invention betaine can be used, for example, as an anhydrous form, or as a hydrate or as an animal feed acceptable salt. In one embodiment, when betaine is present, it is present as the free zwitterion. In one embodiment, when betaine is present, it is present as anhydrous betaine. In one embodiment, when betaine is present, it is present as a monohydrate.

As used herein an “animal feed acceptable salt” means any non-toxic salt that, upon administration to a recipient, is capable of providing, either directly or indirectly, a compound or a derivative of a compound described herein. Acids commonly employed to form acceptable salts include inorganic acids such as hydrogen bisulfide, hydrochloric, hydrobromic, hydroiodic, sulfuric and phosphoric acid, as well as organic acids such as para-toluenesulfonic, salicylic, tartaric, bitartaric, ascorbic, maleic, besylic, fumaric, gluconic, glucuronic, formic, glutamic, methanesulfonic, ethanesulfonic, benzenesulfonic, lactic, oxalic, para-bromophenylsulfonic, carbonic, succinic, citric, benzoic and acetic acid, and related inorganic and organic acids. Such animal feed acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, di nitrobenzoate, hydroxybenzoate, methoxybenzoate, phthalate, terephathalate, sulfonate, xylenesulfonate, phenylacetate, phenylpropionate, phenylbutyrate, citrate, lactate, [beta]-hydroxybutyrate, glycolate, maleate, tartrate, methanesulfonate, propanesulfonate, naphthalene-1-sulfonate, naphthalene-2-sulfonate, mandelate and the like salts. Preferred animal feed acceptable acid addition salts include those formed with mineral acids such as hydrochloric acid and hydrobromic acid, and those formed with organic acids such as maleic acid. Suitable cations for forming feed acceptable salts include ammonium, sodium, potassium, calcium, magnesium and aluminum cations, among others.

As used herein, “essential oil” refers to the set of all the compounds that can be distilled or extracted from the plant from which the oil is derived and that contributes to the characteristic aroma of that plant. See e.g., H. McGee, On Food and Cooking, Charles Scribner's Sons, p. 154-157 (1984). Non-limiting examples of essential oils include thymol and cinnamaldehyde.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number can be a number which, in the context in which it is presented, provides the substantial equivalent of the specifically recited number. For example, in connection with a numerical value, the term “about” refers to a range of −10% to +10% of the numerical value, unless the term is otherwise specifically defined in context.

As used herein, the singular terms “a,” “an,” and “the” include the plural reference unless the context clearly indicates otherwise.

It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is also noted that the term “consisting essentially of,” as used herein refers to a composition wherein the component(s) after the term is in the presence of other known component(s) in a total amount that is less than 30% by weight of the total composition and do not contribute to or interferes with the actions or activities of the component(s).

It is further noted that the term “comprising,” as used herein, means including, but not limited to, the component(s) after the term “comprising.” The component(s) after the term “comprising” are required or mandatory, but the composition comprising the component(s) can further include other non-mandatory or optional component(s).

It is also noted that the term “consisting of,” as used herein, means including, and limited to, the component(s) after the term “consisting of.” The component(s) after the term “consisting of” are therefore required or mandatory, and no other component(s) are present in the composition.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Unless defined otherwise herein, all technical and scientific terms used herein have the same meaning as commonly understood by one of ordinary skill in the art to which this invention pertains.

Other definitions of terms may appear throughout the specification.

### II. Compositions

A. Granules

In one embodiment, provided herein are granules containing one or more active agents (such as an enzyme). Each granule has a core which includes one or more (such as 1, 2, 3, 4, 5, or more) active agents (such as an enzyme) and a carrier having at least one (such as 1, 2, 3, 4, 5, or more) proton acceptor. The core is coated with one or more layers of one or more fats. The enzyme within the granule maintains at least about 50% such as at least about 50%, 55%, 60%, 65%, 70%, 75%, 80%, 85%, 90%, 95%, or 100%, inclusive of all values falling within these percentages) residual activity after being coated.

In further embodiments, the fat-coated granules (such as fat-coated enzyme granules) have a particle size range of 100-1500 μm or 500-1500 μm in diameter, such as about 580-1466 μm, such as any of about 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, 1000 μm, 1050 μm, 1100 μm, 1150 μm, 1200 μm, 1250 μm, 1300 μm, 1350 μm, 1400 μm, 1450 μm, or 1500 μm, in diameter inclusive of all values falling in between these numbers.

In other embodiments, the granules or the dried form of the granules have a particle density of about 0.6-1.2 g/cm³ (equivalent to g/mL) or 0.7-2.0 g/cm³ (such as any of about 0.6 g/cm³, 0.7 g/cm³, 0.8 g/cm³, 0.9 g/cm³, 1 g/cm³, 1.1 g/cm³, 1.2 g/cm³, 1.3 g/cm³, 1.4 g/cm³, 1.5 g/cm³, 1.6 g/cm³, 1.7 g/cm³, 1.8 g/cm³, 1.9 g/cm³, or 2 g/cm³). In further embodiments, the granules or the dried form of the granules have a density of about 0.6-1.3 g/ml, such as any of about 0.6 g/ml, 0.7 g/ml, 0.8 g/ml, 0.9 g/ml, 1 g/ml, 1.1 g/ml, 1.2 g/ml, or 1.3 g/ml.

In some embodiments, the following coating and drying, the granule has a moisture content less than about 15% such as any of less than about 14%, 13%, 12%, 11%, 10%, 9%, 8%, 7%, 6%, 5%, 4%, 3%, 2%, or 1%.

The granule of any of the embodiments disclosed herein can contain from about 30% to about 70% (w/w) fat content, such as about 40% to 60% (w/w), or 45% to 55% (w/w), such as any of about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% (w/w) fat content. In some embodiments the fat is a plant fat, for example, palm oil.

The granule of any of the embodiments disclosed herein can contain from about 10% to about 30% (w/w) carrier content, such as 15% to 25% (w/w), such as any of about 10%, 11%, 12%, 13%, 14%, 15%, 16%, 17%, 18%, 19%, 20%, 21%, 22%, 23%, 24%, 25%, 26%, 27%, 28%, 29%, or 30% (w/w) carrier content. In some embodiments the carrier contains, comprises, or is calcium chloride or limestone.

The granule of any of the embodiments disclosed herein can further contain from about 10% to about 40% (w/w), such as about 15% to 35% (w/w), 20% to 30% (w/w) active agent (such as an enzyme) content, such as any of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% (w/w) active agent (such as an enzyme) content. In some non-limiting embodiments, the active agent is an enzyme (such as a glucoamylase).

The granule of any of the embodiments disclosed herein shortens transit time through the upper gastrointestinal tract (i.e. the rumen, reticulum, omasum and abomasum) to the small intestine of a ruminant animal by any of about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%, compared to granules that do not comprise a core which includes one or more (such as 1, 2, 3, 4, 5, or more) active agents (such as an enzyme) and a carrier having at least one (such as 1, 2, 3, 4, 5, or more) proton acceptor.

B. Carriers

In some embodiments of any of the fat-coated granules provided herein, an active agent (for example, an enzyme) and a proton acceptor are present in the core of the granule which is coated with one or more layers of fat. The proton acceptor can also be generated in a chemical reaction or can be any ionic species capable of binding to and neutralizing a proton. Under the Broensted-Lowry definition, a base acceptor is a negatively charged ion that will react with, or accept, a positively charged hydrogen ion. Since a hydrogen ion is a proton, the base is called a proton acceptor.

Without being bound to theory, the proton acceptor serves to neutralize protons diffusing into the granule while it passes through the highly acidic components of the ruminant upper gastrointestinal tract (for example, the abomasum; see FIG. 3). Neutralization of protons by the proton acceptor can help protect an enzymatic active agent from low pH-mediated degradation or denaturation. Once the granule reaches the small intestine, the fat coating will be dissolved by secreted lipase and bile salts, thereby freeing the enzyme to hydrolyze the starch remaining in the lower gastrointestinal tract that escaped digestion in the rumen.

In one embodiment, the active agent (for example, an enzyme) can be formulated with at least one physiologically acceptable (i.e. non-toxic) carrier comprising at least one proton acceptor. Non-limiting examples of proton acceptors include sodium carbonate (Na₂CO₃), sodium bicarbonate (NaHCO₃), calcium carbonate (CaCO₃, for example, limestone), magnesium carbonate (MgCO₃), sodium acetate (CH₃COONa), calcium acetate (Ca(C₂H₃O₂)₂), Na₂SO₄, citrate, acetate, phosphate, any salt that can be formed from a strong alkali (e.g., NaOH, KOH, etc.) and a weak acid such as carbonic acid (H₂CO₃), and mixtures thereof.

C. Fat Coatings for Granules

In one embodiment, the fat-coating substance decreases the degree of degradation of the feed or feed additive (such as an enzyme) in the rumen environment.

In one embodiment, the fat-coating substance comprises a lipid or an emulsifier. In one embodiment, the fat-coating substance consists essentially of a lipid or an emulsifier. In another embodiment, the fat-coating substance consists of a lipid or an emulsifier.

In one embodiment, the emulsifier is selected from fatty acid monoglycerides, diglycerides, polyglycerol esters and sorbitan esters of fatty acids.

In one embodiment, the lipid is selected from animal oils or fats, vegetable oils or fats, triglycerides, free fatty acids, animal waxes, (such as beeswax, lanolin, shell wax or Chinese insect wax), vegetable waxes (such as carnauba, candelilla, bayberry or sugarcane), mineral waxes, synthetic waxes, natural and synthetic resins and mixtures thereof.

In another embodiment, the lipid is selected from animal oils or fats, vegetable oils or fats, triglycerides, vegetable waxes (such as carnauba, candelilla, bayberry or sugarcane), mineral waxes, synthetic waxes, natural and synthetic resins and mixtures thereof.

In another embodiment, the lipid is selected from hardened vegetable oils or fats, triglycerides, and mixtures thereof. In one embodiment, the lipid is a fat, such as a vegetable-derived fat.

In some embodiments, the fat is solid at room temperature. In other embodiments, the fat has a melting point of about 40° C. or more. In yet other embodiments, the fat has a melting point of about 50° C. or more. In other embodiments, the fat has a melting point of about 60° C. or more. In one embodiment, the fat has a melting point of about 40° C. to about 80° C., or from about 50° C. to about 80° C., or from about 55° C. to about 75° C., or from about 55° C. to about 70° C.

In some embodiments, the fat is a hardened fat, for example, a fully hardened fat. In another embodiment, the coating substance comprises a lipid selected from a hardened fat or a fully hardened fat.

In some embodiments, the fats are free fatty acids (such as, for example, stearic acid, palmitic acid and oleic acid) or derivatives of fatty acids and glycerol.

In other embodiments, the fats are comprised of triglycerides. The term “triglyceride” In some embodiments, means a triester of glycerol and a fatty acid. In some embodiments, the triglyceride is a triester of glycerol, and a C4 to C24 fatty acid. In other embodiments, the triglyceride is selected from triglycerides having a fatty acid chain length of 10 carbons or more, 14 carbons or more, or mixtures thereof. In some embodiments, the triglyceride is selected from triglycerides having a fatty acid chain length of 10 to 20 carbons, 14 to 18 carbons, or mixtures thereof. In another embodiment, the fat comprises triglycerides having a C14, C16 and C18 fatty acid chain length, and mixtures thereof. In some embodiments, the fatty acid of the triglyceride is saturated.

In another embodiment, the fat-coating substance comprises, consists essentially of, or consists of a fat selected from canola oil, cottonseed oil, peanut oil, corn oil, olive oil, soybean oil, sunflower oil, safflower oil, coconut oil, palm oil, linseed oil, tung oil, castor oil and rapeseed oil. In some embodiments, the coating substance comprises, consists essentially of or consists of a fat selected from hardened canola oil, hardened cottonseed oil, hardened peanut oil, hardened corn oil, hardened olive oil, hardened soybean oil, hardened sunflower oil, hardened safflower oil, hardened coconut oil, hardened palm oil, hardened linseed oil, hardened tung oil, hardened castor oil, and hardened rapeseed oil. In other embodiments, the coating substance comprises, consists essentially of, or consists of a fat selected from fully hardened canola oil, hardened cottonseed oil, fully hardened peanut oil, fully hardened corn oil, fully hardened olive oil, fully hardened soybean oil, fully hardened sunflower oil, fully hardened safflower oil, fully hardened coconut oil, fully hardened palm oil, fully hardened linseed oil, fully hardened tung oil, fully hardened castor oil, and fully hardened rapeseed oil.

In another embodiment, the coating substance may further comprise other ingredients, such as inert fillers (e.g. calcium hydrogen phosphate or calcium carbonate). In some embodiments, the inert fillers (e.g. calcium hydrogen phosphate) can be useful for ‘tuning’ the density of the final particle or granule.

In one embodiment, the feed or feed additive is coated wherein the feed or feed additive is encapsulated within a cross-linked aqueous hydrocolloid droplet which itself is encapsulated in a solid fat droplet. In another embodiment, the feed or feed additive is coated with microlayers of a lipid, such as any of the lipids described above. In another embodiment, the feed or feed additive is coated wherein the feed or feed additive and coating substance form a core, and the core is encapsulated with a further coating substance.

In another embodiment, the feed or feed additive is coated wherein the feed or feed additive is dispersed within a lipid (e.g. by spray-cooling). In some embodiments, the lipid is as described above. The resultant coated feed or feed additive forms a core, which is then itself coated (e.g. by hot melt coating) with a layer of lipid to form an encapsulated core. In some embodiments, the lipid comprises a fat as defined above. In further embodiments, the lipid is fully hardened palm oil, fully hardened rapeseed oil, fully hardened cottonseed oil or fully hardened soybean oil.

In one embodiment, the feed or feed additive is coated with hardened palm oil, In some embodiments, microlayers of hardened palm oil. In another embodiment, the feed or feed additive is coated with fully hardened palm oil, In some embodiments, microlayers of fully hardened palm oil.

In another embodiment, the feed or feed additive is coated with ethylcellulose and plasticizer. In some embodiments, the plasticizer is selected from acetic acid esters of mono- and di-glycerides of fatty acids.

In another embodiment, the feed or feed additive is coated (entrapped) inside alginate beads which are further incorporated inside solid lipid beads.

D. Enzymes

In one embodiment, the disclosure relates to fat-coated active agents that retain significant residual activity/potency following the fat-coating process as well as transit though the rumen of a ruminant animal into the small intestine. In some embodiments, the active agents are one or more enzymes. Suitable enzymes for fat coating in accordance with the methods disclosed herein include, without limitation, glucoamylases, xylanases, amylases, phytases, beta-glucanases, and proteases.

1. Glucoamylases

Glucoamylase (1,4-alpha-D-glucan glucohydrolase, EC 3.2.1.3) is an enzyme, which catalyzes the release of D-glucose from the non-reducing ends of starch or related oligo- and poly-saccharide molecules. Glucoamylases are produced by several filamentous fungi and yeast.

In one embodiment, provided herein are feed or feed additive compositions including one or more fat-coated glucoamylase. The glucoamylase may be any commercially available glucoamylase. Suitably the glucoamylase may be an 1,4-alpha-D-glucan glucohydrolase (EC 3.2.1.3). All E.C. enzyme classifications referred to herein relate to the classifications provided in Enzyme Nomenclature—Recommendations (1992) of the nomenclature committee of the International Union of Biochemistry and Molecular Biology—ISBN 0-12-226164-3, which is incorporated herein

Glucoamylases have been used successfully in commercial applications for many years. Additionally, various mutations have been introduced in fungal glucoamylases, for example, Trichoderma reesei glucoamylase (TrGA), to enhance thermal stability and specific activity. See, e.g., WO 2008/045489; WO 2009/048487; WO 2009/048488; and U.S. Pat. No. 8,058,033. In some embodiments, the T. reesei glucoamylase (TrGA) is PDB accession number is 2VN4 A or is SEQ ID NO: 11 from WO2019/173424, incorporated by reference herein. Glucoamylase activity (such as residual activity following fat-coating) can be assessed using any means known in the art, including those described in the Examples section, infra.

A glucoamylase may be derived from any suitable source, e.g., derived from a microorganism or a plant. Glucoamylases can be from fungal or bacterial origin, selected from the group consisting of Aspergillus glucoamylases, in for example, Aspergillus niger G1 or G2 glucoamylase (Boel et al., 1984, EMBO J 3(5): 1097-1102), or variants thereof, such as those disclosed in WO 92/00381, WO 00/04136 and WO 01/04273 (from Novozymes, Denmark); the A. awamori glucoamylase disclosed in WO 84/02921, Aspergillus oryzae glucoamylase (Hata et al., 1991, Agric. Biol. Chem. 55(4): 941-949), or variants or fragments thereof. Other Aspergillus glucoamylase variants include variants with enhanced thermal stability: G137A and G139A (Chen et al., 1996, Prot. Eng. 9: 499-505); D257E and D293E/Q (Chen et al., 1995, Prot. Eng. 8: 575-582); N182 (Chen et al., 1994, Biochem. J. 301: 275-281); disulphide bonds, A246C (Fierobe et al., 1996, Biochemistry 35: 8698-8704; and introduction of Pro residues in positions A435 and 5436 (Li et al., 1997, Protein Eng. 10: 1199-1204. In some embodiments, the A. niger glucoamylase (AnGA) is NCBI accession number XP 001390530.1 or is SEQ ID NO: 10 from WO2019/173424, incorporated by reference herein. In other embodiments, the glucoamylase is from Aspergillus fumigatus and is SEQ ID NO:4 from WO2017112635, incorporated by reference herein.

Other glucoamylases include Athelia rolfsii (previously denoted Corticium rolfsi) glucoamylase (see U.S. Pat. No. 4,727,026 and Nagasaka et al., 1998, Appl. Microbiol. Biotechnol. 50: 323-330), Talaromyces glucoamylases, in particular derived from Talaromyces duponti, Talaromyces emersonii (WO 99/28448), Talaromyces leycettanus (U.S. Pat. No. Re. 32,153), and Talaromyces thermophilus (U.S. Pat. No. 4,587,215). In some embodiments, the glucoamylase is from Wolfiporia cocos having an NCBI access ion number PCH39892.1 or is SEQ ID NO: 8 from WO2019/173424, incorporated by reference herein.

Bacterial glucoamylases include glucoamylases from Clostridium, in particular C. thermoamylolyticum (EP 135138) and C. thermohydrosulfuricum (WO86/01831), Trametes cingulata, Pachykytospora papyracea, and Leucopaxillus giganteus, all disclosed in WO 2006/069289; or Peniophora rufomarginata disclosed in WO2007/124285 or PCT/US2007/066618; or a mixture thereof. A hybrid glucoamylase may be used in the present invention. Examples of hybrid glucoamylases are disclosed in WO 2005/045018. Specific examples include the hybrid glucoamylase disclosed in Tables 1 and 4 of Example 1 (which hybrids are hereby incorporated by reference).

The glucoamylase may have a high degree of sequence identity to any of above mentioned glucoamylases, i.e., at least 70%, at least 75%, at least 80%, at least 85%, at least 90%, at least 95%, at least 96%, at least 97%, at least 98%, at least 99% or even 100% identity to the mature enzymes sequences mentioned above.

Commercially available glucoamylase compositions include AMG 200L; AMG 300L; SAN™ SUPER, SAN™ EXTRA L, SPIRIZYME™ PLUS, SPIRIZYME™ FUEL, SPIRIZYME™ B4U, SPIRIZYME ULTRA, SPIRIZYME™ EXCEL and AMG™ E (from Novozymes A/S, Denmark); OPTIDEX™ 300, GC480™ and GC147™ (from Genencor Int., USA); AMIGASE™ and AMIGASE™ PLUS (from DSM); G-ZYME™ G900, G-ZYME™ and G990 ZR (from Genencor Int.).

2. Xylanases

Xylanase is the name given to a class of enzymes that degrade the linear polysaccharide β-1,4-xylan into xylose, thus breaking down hemicellulose, one of the major components of plant cell walls. Xylanases, e.g., endo-β-xylanases (EC 3.2.1.8) hydrolyze the xylan backbone chain. In one embodiment, provided herein are feed or feed additive compositions comprising and one or more fat-coated xylanase.

In another embodiment, provided herein are feed or feed additive compositions including one or more fat-coated xylanase. In one embodiment, the xylanase may be any commercially available xylanase. Suitably the xylanase may be an endo-1,4-P-d-xylanase (classified as E.G. 3.2.1.8) or a 1,4β-xylosidase (classified as E.G. 3.2.1.37). All E.C. enzyme classifications referred to herein relate to the classifications provided in Enzyme Nomenclature—Recommendations (1992) of the nomenclature committee of the International Union of Biochemistry and Molecular Biology—ISBN 0-12-226164-3, which is incorporated herein

In another embodiment, the xylanase may be a xylanase from Bacillus, Trichodermna, Therinomyces, Aspergillus and Penicillium. In still another embodiment, the xylanase may be the xylanase in Axtra XAP® or Avizyme 1502®, both commercially available products from Danisco A/S. In one embodiment, the xylanase may be a mixture of two or more xylanases. In still another embodiment, the xylanase is an endo-1,4-β-xylanase or a 1,4-β-xylosidase. In yet another embodiment, the xylanase is from an organism selected from the group consisting of: Bacillus, Trichoderma, Thermomyces, Aspergillus, Penicillium, and Humicola. In yet another embodiment, the xylanase may be one or more of the xylanases or one or more of the commercial products recited in Table 1.

TABLE 1
Representative commercial xylanases

| Commercial | | | |
|---|---|---|---|
| Name ® | Company | xylanase type | xylanase source |
| [symbol] PT | Alltech | endo-1,4-β- | Aspergillus |
| | | xylanases | Niger |
| Amylofeed | Andres | endo-1,4-β- | Aspergillus |
| | Pintaluba | xylanases | Niger |
| | S. A | | [symbol] |
| Avemix 02 | Aveve | endo-1,4-β- | Trichoderma |
| CS | | xylanases | ressei |
| Avemix XG | Aveve, NL | endo-1,4-β- | Trichoderma |
| 10 | | xylanases | ressei |
| Avizyme | Danisco | endo-1,4-β- | Trichoderma |
| 1100 | | xylanases | longibrachiatum |
| Avizyme | Danisco | endo-1,4-β- | Trichoderma |
| 1110 | | xylanases | longibrachiatum |
| Avizyme | Danisco | endo-1,4-β- | Trichoderma |
| 1202 | | xylanases | longibrachiatum |
| Avizyme | Danisco | endo-1,4-β- | Trichoderma |
| 1210 | | xylanases | longibrachiatum |
| Avizyme | Danisco | endo-1,4-β- | Trichoderma |
| 1302 | | xylanases | longibrachiatum |
| Avizyme | Danisco | endo-1,4-β- | Trichoderma |
| 1500 | | xylanases | longibrachiatum |
| Avizyme | Danisco | endo-1,4-β- | Trichoderma |
| 1505 | | xylanases | longibrachiatum |
| Avizyme | Danisco | endo-1,4-β- | Trichoderma |
| SX | | xylanases | longibrachiatum |
| Biofeed MP | Beiderm | endo-1,4-β- | Bacillus |
| 100 | | xylanases | subtilis |
| Biofeed | DSM | endo-1,4-β- | Humicola |
| Plus | | xylanases | [symbol] |
| Danisco | Danisco | endo-1,4-β- | Trichoderma |
| Glycosintase | Animal | xylanases | ressei |
| (TPT/L) | Nutrition | endo-1,4-β- | Trichoderma |
| Danisco | Danisco | xylanases | ressei |
| Xylanase | | | |
| Econase XT | AB Vista | endo-1,4-β- | Trichoderma |
| | | xylanases | ressei |
| Endofeed ® | Andres | endo-1,4-β- | Aspergillus |
| DC | Pintaluba | xylanases | Niger |
| | S. A | | |
| [symbol] | Lyven | endo-1,4-β- | Trichoderma |
| AXL | | xylanases | longibrachiatum |
| Grindazym | Danisco | endo-1,4-β- | Aspergillus |
| GP | | xylanases | Niger |
| Grindazym | Danisco | endo-1,4-β- | Aspergillus |
| GV | | xylanases | Niger |
| Hostazym X | Huvepharma | endo-1,4-β- | Trichoderma |
| | | xylanases | longibrachiatum |
| Kemzyme | kemin | endo-1,4-β- | Trichoderma |
| Plus Dry | | xylanases | Viride |
| Kemzyme | kemin | endo-1,4-β- | Trichoderma |
| Plus liquid | | xylanases | Viride |
| Kemzyme | kemin | endo-1,4-β- | Trichoderma |
| W Dry | | xylanases | Viride |
| Kemzyme | kemin | endo-1,4-β- | Trichoderma |
| W liquid | | xylanases | Viride |
| Natugrain | BASF | endo-1,4-β- | Trichoderma |
| | | xylanases | longibrachiatum |
| Natugrain | BASF | endo-1,4-β- | Aspergillus |
| TS Plus | | xylanases | Niger |
| Natugrain | BASF | endo-1,4-β- | Aspergillus |
| Wheat | | xylanases | Niger |
| Natugrain ® | BASF | endo-1,4-β- | Aspergillus |
| T6/L | | xylanases | Niger |
| Naturzyme | Bioproton | endo-1,4-β- | Trichoderma |
| | | xylanases | longibrachiatum/ |
| | | | Trichoderma |
| | | | ressei |
| Porzyme | Danisco | endo-1,4-β- | Trichoderma |
| 6100 | | xylanases | longibrachiatum |
| Porzyme | Danisco | endo-1,4-β- | Trichoderma |
| 8300 | | xylanases | longibrachiatum |
| Porzyme | Danisco | endo-1,4-β- | Trichoderma |
| 9102 | | xylanases | longibrachiatum |
| Porzyme | Danisco | endo-1,4-β- | Trichoderma |
| 9310/ | | xylanases | longibrachiatum |
| Avizyme | | | |
| 1310 | | | |
| Porzyme | Danisco | endo-1,4-β- | Trichoderma |
| tp 100 | | xylanases | longibrachiatum |
| Ronozyme | DSM | endo-1,4-β- | Thermomyces |
| AX | | xylanases | lanuginosus |
| | | | gene |
| | | | expressed in |
| | | | Aspergillus |
| | | | oryzae |
| Ronozyme | DSM/ | endo-1,4-β- | Thermomyces |
| WX | Novozymes | xylanases | lanuginosus |
| | | | gene |
| | | | expressed in |
| | | | Aspergillus |
| | | | oryzae |
| Rovabin | Adisseo | endo-1,4-β- | Penicillium |
| Excel | | xylanases | funiculosum |
| Roxazyme | DSM/ | endo-1,4-β- | Trichoderma |
| G2 | Monozymes | xylanases | longibrachiatum |
| Safizym | La Saffre | endo-1,4-β- | Trichoderma |
| X | | xylanases | longibrachiatum |
| Xylanase | Lyven | endo-1,4-β- | Trichoderma |
| | | xylanases | longibrachiatum |

[symbol]

indicates data missing or illegible when filed

In one embodiment, the disclosure relates to a feed or feed additive composition comprising one or more fat-coated xylanase. In one embodiment, the composition comprises 10-50, 50-100, 100-150, 150-200, 200-250, 250-300, 300-350, 350-400, 400-450, 450-500, 500-550, 550-600, 600-650, 650-700, 700-750, and greater than 750 xylanase units/g of composition.

In one embodiment, the composition comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, and greater than 8000 xylanase units/g composition.

It will be understood that one xylanase unit (XU) is the amount of enzyme that releases 0.5 μmol of reducing sugar equivalents (as xylose by the Dinitrosalicylic acid (DNS) assay-reducing sugar method) from an oat-spelt-xylan substrate per min at pH 5.3 and 50° C. (Bailey, et al., Journal of Biotechnology, Volume 23, (3), May 1992, 257-270).

3. Amylases

Amylase is a class of enzymes capable of hydrolysing starch to shorter-chain oligosaccharides, such as maltose. The glucose moiety can then be more easily transferred from maltose to a monoglyceride or glycosylmonoglyceride than from the original starch molecule. The term amylase includes α-amylases (E.G. 3.2.1.1), G4-forming amylases (E.G. 3.2.1.60), β-amylases (E.G. 3.2.1.2) and γ-amylases (E.C. 3.2.1.3). Amylases may be of bacterial or fungal origin, or chemically modified or protein engineered mutants. In another embodiment, provided herein are feed or feed additive compositions including one or more fat-coated amylase.

In one embodiment, the amylase may be a mixture of two or more amylases. In another embodiment, the amylase may be an amylase, e.g. an α-amylase, from Bacillus licheniformis and an amylase, e.g. an α-amylase, from Bacillus amyloliquefaciens, Geobacillus stearothermophilus, Aspergillus kawachii and A. clavatus and variants thereof. In one embodiment, the α-amylase may be the α-amylase in Axtra XAP® or Avizyme 1502®, both commercially available products from Danisco A/S. In yet another embodiment, the amylase may be a pepsin resistant α-amylase, such as a pepsin resistant Trichoderma (such as Trichoderma reesei) alpha amylase. A suitably pepsin resistant α-amylase is taught in UK application number 101 1513.7 (which is incorporated herein by reference) and PCT/IB2011/053018 (which is incorporated herein by reference).

In one embodiment, the amylase for use in the present invention may be one or more of the amylases in one or more of the commercial products recited in Table 2.

TABLE 2

| Commercial | | | |
|---|---|---|---|
| Product ® | Company | Amylase type | Amylase source |
| Amylofeed | Andres | alpha amylase | Aspergillus oryzae |
| | Pintaluba S. A | | |
| Avizyme 1500 | Danisco | alpha amylase | Bacillus amyloliquefaciens |
| Avizyme 1505 | Danisco | alpha amylase | Bacillus amyloliquefaciens |
| Kemzyme | Kemin | alpha-amylase | Bacillus amyloliquefaciens |
| Plus Dry | | | |
| Kemzyme Plus | Kemin | alpha-amylase | Bacillus amyloliquefaciens |
| Liquid | | | |
| Kemzyme | Kemin | alpha-amylase | Bacillus amyloliquefaciens |
| W dry | | | |
| Kemzyme W | Kemin | alpha-amylase | Bacillus amyloliquefaciens |
| Liquid | | | |
| Naturzyme | Bioproton | alpha-amylase | Trichoderma |
| | | | longibrachiatum/ |
| | | | Trichoderma ressei |
| Porzyme 8100 | Danisco | alpha-amylase | Bacillus amyloliquefaciens |
| Porzyme tp100 | Danisco | alpha-amylase | Bacillus amyloliquefaciens |
| Ronozyme A | DSM/ | alpha-amylase | Bacillus amyloliquefaciens |
| | Novozymes | | |
| Ronozyme AX | DSM | alpha-amylase | Bacillus amyloliquefaciens |
| Ronozyme ® | DSM/ | alpha-amylase | Bacillus stearothermophilus |
| RumlStar | Novozymes | | expressed in Bacillus |
| (L/CT) | | | licheniformis |

It will be understood that one amylase unit (AU) is the amount of enzyme that releases 1 mmol of glucosidic linkages from a water insoluble cross-linked starch polymer substrate per min at pH 6.5 and 37° C. (this may be referred to herein as the assay for determining 1 AU).

In one embodiment, the disclosure relates to a feed or feed additive composition comprising one or more fat-coated amylase. In one embodiment, the composition comprises 10-50, 50-100, 100-150, 150-200, 200-250, 250-300, 300-350, 350-400, 400-450, 450-500, 500-550, 550-600, 600-650, 650-700, 700-750, and greater than 750 amylase units/g composition.

In one embodiment, the composition comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, 8000-8500, 8500-9000, 9000-9500, 9500-10000, 10000-11000, 11000-12000, 12000-13000, 13000-14000, 14000-15000 and greater than 15000 amylase units/g composition.

4. Proteases

The term protease as used herein is synonymous with peptidase or proteinase. The protease may be a subtilisin (E.G. 3.4.21.62) and variants thereof, or a bacillolysin (E.G. 3.4.24.28) or an alkaline serine protease (E.G. 3.4.21.x) or a keratinase (E.G. 3.4.X.X). In one embodiment, the protease is a subtilisin. Suitable proteases include those of animal, vegetable or microbial origin. Chemically modified or protein engineered mutants are also suitable. The protease may be a serine protease or a metalloprotease. e.g., an alkaline microbial protease or a trypsin-like protease. In another embodiment, provided herein are feed or feed additive compositions including one or more fat-coated protease.

Examples of alkaline proteases are subtilisins, especially those derived from Bacillus sp., e.g., subtilisin Novo, subtilisin Carlsberg, subtilisin 309 (see, e.g., U.S. Pat. No. 6,287,841), subtilisin 147, and subtilisin 168 (see, e.g., WO 89/06279). Examples of trypsin-like proteases are trypsin (e.g., of porcine or bovine origin), and Fusarium proteases (see, e.g., WO 89/06270 and WO 94/25583). Example of chymotrypsin-like proteases can include Ronozyme ProACT® from DSM and those described in WO2013189972 2013. Examples of useful proteases also include but are not limited to the variants described in WO 92/19729 and WO 98/20115.

In another embodiment, the protease may be one or more of the proteases in one or more of the commercial products recited in Table 3.

TABLE 3
Representative commercial proteases

| Commercial | | | |
|---|---|---|---|
| Product ® | Company | Phytase type | Phytase source |
| Finase | ABVista | 3-Phytase | Trichoderma ressei |
| Finase EC | ABVista | 6-Phytase | E. coli gene expressed in |
| | | | Trichoderma ressei |
| Natuphos | BASF | 3-Phytase | Aspergillus Niger |
| Natuzyme | Bioproton | Phytase | Trichoderma |
| | | (type not | longibrachlatum/ |
| | | specified) | Trichoderma ressei |
| OPTIPHOS ® | Huvepharma | 6-Phytase | E. coli gene expressed in |
| | AD | | pichia pastoris |
| Phytase sp1002 | DSM | 3-Phytase | A. consensus gene expressed |
| | | | in hansenula polymorpha |
| Phyzyme XP | Danisco | 6-Phytase | E. coli gene expressed in |
| | | | schizosaccahomyces pombe |
| Quantum | ABVista | 6-Phytase | E. coli gene expressed in |
| 2500D, | | | Pichla pastoris or |
| 5000L | | | Trichoderma |
| Ronozyme | DSM/ | 6-Phytase | Citrobacter braakii gene |
| Hi-Phos | Novozymes | | expressed in Aspergillus |
| (M/L) | | | oryzae |
| Ronozyme NP | DSM/ | 6-Phytase | Peniphora lycii gene |
| | Novozymes | | expressed in Aspergillus |
| | | | oryzae |
| Ronozyme P | DSM/ | 6-Phytase | Peniphora lycii gene |
| | Novozymes | | expressed in Aspergillus |
| | | | oryzae |
| Rovablo PHY | Adissec | 3-Phytase | Penicillum funiculosum |

In one embodiment, the protease is selected from the group consisting of subtilisin, a bacillolysin, an alkine serine protease, a keratinase, and a Nocardiopsis protease.

It will be understood that one protease unit (PU) is the amount of enzyme that liberates from the substrate (0.6% casein solution) one microgram of phenolic compound (expressed as tyrosine equivalents) in one minute at pH 7.5 (40 mM Na₂PO₄/lactic acid buffer) and 40° C. This may be referred to as the assay for determining 1 PU.

In one embodiment, the disclosure relates to a feed or feed additive composition comprising one or more fat-coated protease. In another embodiment, the disclosure relates to a feed or feed additive composition comprising one or more fat-coated xylanase and protease. In still another embodiment, the disclosure relates to a feed or feed additive composition comprising one or more fat-coated amylase and protease. In yet another embodiment, the disclosure relates to a feed or feed additive composition comprising one or more fat-coated xylanase, amylase and protease.

In one embodiment, the composition comprises 10-50, 50-100, 100-150, 150-200, 200-250, 250-300, 300-350, 350-400, 400-450, 450-500, 500-550, 550-600, 600-650, 650-700, 700-750, and greater than 750 protease units/g composition.

In one embodiment, the composition comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, 8000-8500, 8500-9000, 9000-9500, 9500-10000, 10000-11000, 11000-12000, 12000-13000, 13000-14000, 14000-15000 and greater than 15000 protease units/g composition.

5. Phytases

In another embodiment, provided herein are feed or feed additive compositions including one or more fat-coated phytase. The phytase for use in the present invention may be classified a 6-phytase (classified as E.C. 3.1.3.26) or a 3-phytase (classified as E.C. 3.1.3.8). In one embodiment, the phytase for use in the present invention may be one or more of the phytases in one or more of the commercial products below in Table 4:

In one embodiment the phytase is a Citrobacter phytase derived from e.g. Citrobacter freundii, In some embodiments, C. freundii NCIMB 41247 and variants thereof e.g. as disclosed in WO2006/038062 (incorporated herein by reference) and WO2006/038128 (incorporated herein by reference), Citrobacter braakii YH-15 as disclosed in WO 2004/085638, Citrobacter braakii ATCC 51113 as disclosed in WO2006/037328 (incorporated herein by reference), as well as variants thereof e.g. as disclosed in WO2007/112739 (incorporated herein by reference) and WO2011/117396 (incorporated herein by reference), Citrobacter amalonaticus, In some embodiments, Citrobacter amalonaticus ATCC 25405 or Citrobacter amalonaticus ATCC 25407 as disclosed in WO2006037327 (incorporated herein by reference), Citrobacter gillenii, In some embodiments, Citrobacter gillenii DSM 13694 as disclosed in WO2006037327 (incorporated herein by reference), or Citrobacter intermedius, Citrobacter koseri, Citrobacter murliniae, Citrobacter rodentium, Citrobacter sedlakii, Citrobacter werkmanii, Citrobacter youngae, Citrobacter species polypeptides or variants thereof.

In some embodiments, the phytase is an E. coli phytase marketed under the name Phyzyme XP™ Danisco A/S. Alternatively, the phytase may be a Buttiauxella phytase, e.g. a Buttiauxella agrestis phytase, for example, the phytase enzymes taught in WO 2006/043178, WO 2008/097619, WO2009/129489, WO2008/092901, PCT/US2009/41011 or PCT/IB2010/051804, WO2020/106796, all of which are incorporated herein by reference.

In one embodiment, the phytase may be a phytase from Hafnia, e.g. from Hafnia alvei, such as the phytase enzyme(s) taught in US2008263688, which reference is incorporated herein by reference. In one embodiment, the phytase may be a phytase from Aspergillus, e.g. from Aspergillus oryzae. In one embodiment, the phytase may be a phytase from Penicillium, e.g. from Penicillium funiculosum.

In some embodiments, the phytase is present in the feed or feed-additive compositions in range of about 200 FTU/kg to about 1000 FTU/kg feed. In some embodiments, about 300 FTU/kg feed to about 750 FTU/kg feed. In some embodiments, about 400 FTU/kg feed to about 500 FTU/kg feed. In one embodiment, the phytase is present in the feedstuff at more than about 200 FTU/kg feed, suitably more than about 300 FTU/kg feed, suitably more than about 400 FTU/kg feed. In one embodiment, the phytase is present in the feedstuff at less than about 1000 FTU/kg feed, suitably less than about 750 FTU/kg feed. In some embodiments, the phytase is present in the feed additive composition in range of about 40 FTU/g to about 40,000 FTU/g composition; about 80 FTU/g composition to about 20,000 FTU/g composition; about 100 FTU/g composition to about 10,000 FTU/g composition; and about 200 FTU/g composition to about 10,000 FTU/g composition. In one embodiment, the phytase is present in the feed additive composition at more than about 40 FTU/g composition, suitably more than about 60 FTU/g composition, suitably more than about 100 FTU/g composition, suitably more than about 150 FTU/g composition, suitably more than about 200 FTU/g composition. In one embodiment, the phytase is present in the feed additive composition at less than about 40,000 FTU/g composition, suitably less than about 20,000 FTU/g composition, suitably less than about 15,000 FTU/g composition, suitably less than about 10,000 FTU/g composition.

It will be understood that as used herein 1 FTU (phytase unit) is defined as the amount of enzyme required to release 1 μmol of inorganic orthophosphate from a substrate in one minute under the reaction conditions defined in the ISO 2009 phytase assay—A standard assay for determining phytase activity and 1 FTU can be found at International Standard ISO/DIS 30024: 1-17, 2009. In one embodiment, the enzyme is classified using the E.C. classification above, and the E.C. classification designates an enzyme having that activity when tested in the assay taught herein for determining 1 FTU.

E. Direct Fed Microbials (DFMs)

In one embodiment, a DFM can be included in the fat-coated enzyme-containing DFM formulations disclosed herein and, optionally, may be formulated as a liquid, a dry powder or a granule. In one embodiment, the DFMs and fat-coated enzymes can be formulated as a single mixture. In another embodiment, the DFMs and fat-coated enzymes can be formulated as separate mixtures. In still another embodiment, separate mixtures of DFMs and the fat-coated enzymes can be administered at the same time or at different times. In still another embodiment, separate mixtures of DFMs and fat-coated enzymes can be administered simultaneously or sequentially. In yet another embodiment, a first mixture comprising DFMs can be administered followed by a second mixture comprising fat-coated enzymes. In still another embodiment, a first mixture comprising fat-coated enzymes can be administered followed by a second mixture comprising DFMs.

The dry powder or granules may be prepared by means known to those skilled in the art, such as, in top-spray fluid bed coater, in a fluid bed using either top-spray or bottom-spray Wurster configuration or by drum granulation (e.g. High sheer granulation), extrusion, pan coating or in a microingredients mixer.

In another embodiment, the DFM and/or the fat-coated enzyme(s) may be coated, for example encapsulated. Suitably the DFM and fat-coated enzymes may be formulated within the same coating or encapsulated within the same capsule. Alternatively, one or more of the fat-coated enzymes may be formulated within the same coating or encapsulated within the same capsule while the DFM can be formulated in a separate coating from the fat-coated enzymes.

In some embodiments, such as where the DFM is capable of producing endospores, the DFM may be provided without any coating. In such circumstances, the DFM endospores may be simply admixed with one or more fat-coated enzymes. The fat-coated enzymes may be encapsulated as mixtures (i.e. comprising one or more, two or more, three or more or all) of enzymes or they may be encapsulated separately, e.g. as single enzymes. In one preferred embodiment, all fat-coated enzymes may be coated, e.g. encapsulated, together. In one embodiment, the coating protects the enzymes from degradation, denaturation, and/or deactivation in the rumen of a ruminant animal.

In another embodiment, the DFMs and fat-coated feed enzymes may be mixed with feed or administered in the drinking water. In one embodiment, the dosage range for inclusion into water is about 1×10³ CFU/animal/day to about 1×10¹⁰ CFU/animal/day, for example, about 1×10⁷ CFU/animal/day.

At least one DFM may comprise at least one viable microorganism such as a viable bacterial strain or a viable yeast or a viable fungi. In some embodiments, the DFM comprises at least one viable bacteria. It is possible that the DFM may be a spore forming bacterial strain and hence the term DFM may be comprised of or contain spores, e.g. bacterial spores. Thus, the term “viable microorganism” as used herein may include microbial spores, such as endospores or conidia. Alternatively, the DFM in the feed additive composition described herein may not comprise of or may not contain microbial spores, e.g. endospores or conidia. The microorganism may be a naturally-occurring microorganism or it may be a transformed microorganism.

A DFM as described herein may comprise microorganisms from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium and Megasphaera and combinations thereof. In some embodiments, the DFM comprises one or more bacterial strains selected from the following Bacillus spp: Bacillus subtilis, Bacillus cereus, Bacillus licheniformis, Bacillus pumilis and Bacillus amyloliquefaciens.

The genus “Bacillus”, as used herein, includes all species within the genus “Bacillus,” as known to those of skill in the art, including but not limited to B. subtilis, B. licheniformis, B. lentus, B. brevis, B. stearothermophilus, B. alkalophilus, B. amyloliquefaciens, B. clausii, B. halodurans, B. megaterium, B. coagulans, B. circulans, B. gibsonii, B. pumilis and B. thuringiensis. It is recognized that the genus Bacillus continues to undergo taxonomical reorganization. Thus, it is intended that the genus include species that have been reclassified, including but not limited to such organisms as Bacillus stearothermophilus, which is now named “Geobacillus stearothermophilus”, or Bacillus polymyxa, which is now “Paenibacillus polymyxa” The production of resistant endospores under stressful environmental conditions is considered the defining feature of the genus Bacillus, although this characteristic also applies to the recently named Alicyclobacillus, Amphibacillus, Aneurinibacillus, Anoxybacillus, Brevibacillus, Filobacillus, Gracilibacillus, Halobacillus, Paenibacillus, Salibacillus, Thermobacillus, Ureibacillus, and Virgibacillus.

In another aspect, the DFM may be further combined with the following Lactococcus spp: Lactococcus cremoris and Lactococcus lactis and combinations thereof. The DFM may be further combined with the following Lactobacillus spp: Lactobacillus buchneri, Lactobacillus acidophilus, Lactobacillus casei, Lactobacillus kefiri, Lactobacillus bifidus, Lactobacillus brevis, Lactobacillus helveticus, Lactobacillus paracasei, Lactobacillus rhamnosus, Lactobacillus salivarius, Lactobacillus curvatus, Lactobacillus bulgaricus, Lactobacillus sakei, Lactobacillus reuteri, Lactobacillus fermentum, Lactobacillus farciminis, Lactobacillus lactis, Lactobacillus delbreuckii, Lactobacillus plantarum, Lactobacillus paraplantarum, Lactobacillus farciminis, Lactobacillus rhamnosus, Lactobacillus crispatus, Lactobacillus gasseri, Lactobacillus johnsonii and Lactobacillus jensenii, and combinations of any thereof.

In still another aspect, the DFM may be further combined with the following Bifidobacteria spp: Bifidobacterium lactis, Bifidobacterium bifidum, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum, and combinations of any thereof.

There can be mentioned bacteria of the following species: Bacillus subtilis, Bacillus licheniformis, Bacillus amyloliquefaciens, Bacillus pumilis, Enterococcus, Enterococcus spp, and Pediococcus spp, Lactobacillus spp, Bifidobacterium spp, Lactobacillus acidophilus, Pediococsus acidilactici, Lactococcus lactis, Bifidobacterium bifidum, Bacillus subtilis, Propionibacterium thoenii, Lactobacillus farciminis, Lactobacillus rhamnosus, Megasphaera elsdenii, Clostridium butyricum, Bifidobacterium animalis ssp. animalis, Lactobacillus reuteri, Bacillus cereus, Lactobacillus salivarius ssp. Salivarius, Propionibacterium sp and combinations thereof.

A direct-fed microbial described herein comprising one or more bacterial strains may be of the same type (genus, species and strain) or may comprise a mixture of genera, species and/or strains. Alternatively, a DFM may be combined with one or more of the products or the microorganisms contained in those products disclosed in WO2012110778 and summarized as follows: Bacillus subtilis strain 2084 Accession No. NRRLB-50013, Bacillus subtilis strain LSSAO1 Accession No. NRRL B-50104, and Bacillus subtilis strain 15A-P4 ATCC Accession No. PTA-6507 (from Enviva Pro®. (formerly known as Avicorr®); Bacillus subtilis Strain C3102 (from Calsporin®); Bacillus subtilis Strain PB6 (from Clostat®); Bacillus pumilis (8G-134); Enterococcus NCIMB 10415 (SF68) (from Cylactin®); Bacillus subtilis Strain C3102 (from Gallipro® & GalliproMax®); Bacillus licheniformis (from Gallipro® Tect®); Enterococcus and Pediococcus (from Poultry star®); Lactobacillus, Bifidobacterium and/or Enterococcus from Protexin®); Bacillus subtilis strain QST 713 (from Proflora®); Bacillus amyloliquefaciens CECT-5940 (from Ecobiol® & Ecobiol® Plus); Enterococcus faecium SF68 (from Fortiflora®); Bacillus subtilis and Bacillus licheniformis (from BioPlus2B®); Lactic acid bacteria 7 Enterococcus faecium (from Lactiferm®); Bacillus strain (from CSI®); Saccharomyces cerevisiae (from Yea-Sacc®); Enterococcus (from Biomin IMB52®); Pediococcus acidilactici, Enterococcus, Bifidobacterium animalis ssp. animalis, Lactobacillus reuteri, Lactobacillus salivarius ssp. salivarius (from Biomin C5®); Lactobacillus farciminis (from Biacton®); Enterococcus (from Oralin E1707®); Enterococcus (2 strains), Lactococcus lactis DSM 1103 (from Probios-pioneer PDFM®); Lactobacillus rhamnosus and Lactobacillus farciminis (from Sorbiflore®); Bacillus subtilis (from Animavit®); Enterococcus (from Bonvital®); Saccharomyces cerevisiae (from Levucell SB 20®); Saccharomyces cerevisiae (from Levucell SC 0 & SC10® ME); Pediococcus acidilacti (from Bactocell); Saccharomyces cerevisiae (from ActiSaf® (formerly BioSaf®)); Saccharomyces cerevisiae NCYC Sc47 (from Actisaf® SC47); Clostridium butyricum (from Miya-Gold®); Enterococcus (from Fecinor and Fecinor Plus®); Saccharomyces cerevisiae NCYC R-625 (from InteSwine®); Saccharomyces cerevisia (from BioSprint®); Enterococcus and Lactobacillus rhamnosus (from Provita®); Bacillus subtilis and Aspergillus oryzae (from PepSoyGen-C®); Bacillus cereus (from Toyocerin®); Bacillus cereus var. toyoi NCIMB 40112/CNCM 1-1012 (from TOYOCERIN®), or other DFMs such as Bacillus licheniformis and Bacillus subtilis (from BioPlus® YC) and Bacillus subtilis (from GalliPro®).

The DFM may be combined with Enviva® PRO which is commercially available from Danisco A/S. Enviva Pro® is a combination of Bacillus strain 2084 Accession No. NRRL B-50013, Bacillus strain LSSAO1 Accession No. NRRL B-50104 and Bacillus strain 15A-P4 ATCC Accession No. PTA-6507 (as taught in U.S. Pat. No. 7,754,469 B—incorporated herein by reference). Preferably, the DFM described herein comprises microorganisms which are generally recognized as safe (GRAS) and, preferably are GRAS-approved. A person of ordinary skill in the art will readily be aware of specific species and/or strains of microorganisms from within the genera described herein which are used in the food and/or agricultural industries and which are generally considered suitable for animal consumption.

In some embodiments, it is important that the DFM be heat tolerant, i.e. is thermotolerant. This is particularly the case when the feed is pelleted. Therefore, in another embodiment, the DFM may be a thermotolerant microorganism, such as a thermotolerant bacteria, including for example Bacillus spp.

In other aspects, it may be desirable that the DFM comprises a spore producing bacteria, such as Bacilli, e.g. Bacillus spp. Bacilli are able to form stable endospores when conditions for growth are unfavorable and are very resistant to heat, pH, moisture and disinfectants.

The DFM described herein may decrease or prevent intestinal establishment of pathogenic microorganism (such as Clostridium perfringens and/or E. coli and/or Salmonella spp and/or Campylobacter spp.). In other words, the DFM may be antipathogenic. The term “antipathogenic” as used herein means the DFM counters an effect (negative effect) of a pathogen.

As described above, the DFM may be any suitable DFM. For example, the following assay “DFM ASSAY” may be used to determine the suitability of a microorganism to be a DFM. The DFM assay as used herein is explained in more detail in US2009/0280090. For avoidance of doubt, the DFM selected as an inhibitory strain (or an antipathogenic DFM) in accordance with the “DFM ASSAY” taught herein is a suitable DFM for use in accordance with the present disclosure, i.e. in the feed additive composition according to the present disclosure. Tubes were seeded each with a representative pathogen (e.g., bacteria) from a representative cluster. Supernatant from a potential DFM, grown aerobically or anaerobically, is added to the seeded tubes (except for the control to which no supernatant is added) and incubated. After incubation, the optical density (OD) of the control and supernatant treated tubes was measured for each pathogen. Colonies of (potential DFM) strains that produced a lowered OD compared with the control (which did not contain any supernatant) can then be classified as an inhibitory strain (or an antipathogenic DFM). Thus, The DFM assay as used herein is explained in more detail in US2009/0280090. In some embodiments, a representative pathogen used in this DFM assay can be one (or more) of the following: Clostridium, such as Clostridium perfringens and/or Clostridium difficile, and/or E. coli and/or Salmonella spp and/or Campylobacter spp. In one preferred embodiment, the assay is conducted with one or more of Clostridium perfringens and/or Clostridium difficile and/or E. coli, preferably Clostridium perfringens and/or Clostridium difficile, more preferably Clostridium perfringens.

Antipathogenic DFMs include one or more of the following bacteria and are described in WO2013029013: Bacillus subtilis strain 3BP5 Accession No. NRRL B-50510, Bacillus amyloliquefaciens strain 918 ATCC Accession No. NRRL B-50508, and Bacillus amyloliquefaciens strain 1013 ATCC Accession No. NRRL B-50509.

DFMs may be prepared as culture(s) and carrier(s) (where used) and can be added to a ribbon or paddle mixer and mixed for about 15 minutes, although the timing can be increased or decreased. The components are blended such that a uniform mixture of the cultures and carriers result. The final product is preferably a dry, flowable powder. The DFM(s) comprising one or more bacterial strains can then be added to animal feed or a feed premix, added to an animal's water, or administered in other ways known in the art (preferably simultaneously with the enzymes described herein. Inclusion of the individual strains in the DFM mixture can be in proportions varying from 1% to 99% and, preferably, from 25% to 75% Suitable dosages of the DFM in animal feed may range from about 1×10³ CFU/g feed to about 1×10¹⁰ CFU/g feed, suitably between about 1×10⁴ CFU/g feed to about 1×10⁸ CFU/g feed, suitably between about 7.5×10⁴ CFU/g feed to about 1×10⁷ CFU/g feed. In another aspect, the DFM may be dosed in feedstuff at more than about 1×10³ CFU/g feed, suitably more than about 1×10⁴ CFU/g feed, suitably more than about 5×10⁴ CFU/g feed, or suitably more than about 1×10⁵ CFU/g feed.

The DFM may be dosed in a feed additive composition from about 1×10³ CFU/g composition to about 1×10¹³ CFU/g composition, preferably 1×10⁵ CFU/g composition to about 1×10¹³ CFU/g composition, more preferably between about 1×10⁶ CFU/g composition to about 1×10¹² CFU/g composition, and most preferably between about 3.75×10⁷ CFU/g composition to about 1×10¹¹ CFU/g composition. In another aspect, the DFM may be dosed in a feed additive composition at more than about 1×10⁵ CFU/g composition, preferably more than about 1×10⁶ CFU/g composition, and most preferably more than about 3.75×10⁷ CFU/g composition. In one embodiment, the DFM is dosed in the feed additive composition at more than about 2×10⁵ CFU/g composition, suitably more than about 2×10⁶ CFU/g composition, suitably more than about 3.75×10⁷ CFU/g composition.

F. Feed Additive Compositions

In one embodiment, provided herein are feed additive compositions comprising one or more of the fat-coated granules (such as fat-coated enzyme granules) disclosed herein.

In one embodiment, the feed additive composition may be used in the form of solid or liquid preparations or alternatives thereof. Examples of solid preparations include powders, pastes, boluses, capsules, ovules, pills, pellets, tablets, dusts, and granules which may be wettable, spray-dried or freeze-dried. Examples of liquid preparations include, but are not limited to, aqueous, organic or aqueous-organic solutions, suspensions and emulsions.

In another embodiment, the feed additive composition can be used in a solid form. In one embodiment, the solid form is a pelleted form. In solid form, the feed additive composition may also contain one or more of: excipients such as microcrystalline cellulose, lactose, sodium citrate, calcium carbonate, dibasic calcium phosphate and glycine; disintegrants such as starch (In some embodiments, corn, potato or tapioca starch), sodium starch glycollate, croscarmellose sodium and certain complex silicates; granulation binders such as polyvinylpyrrolidone, hydroxypropylmethylcellulose (HPMC), hydroxypropylcellulose (HPC), sucrose, gelatin and acacia; lubricating agents such as magnesium stearate, stearic acid, glyceryl behenate and talc may be included.

Examples of nutritionally acceptable carriers (in addition to carriers comprising at least one proton acceptor for inclusion in the granule core) for use in preparing the forms include, for example, water, salt solutions, alcohol, silicone, waxes, petroleum jelly, vegetable oils, polyethylene glycols, propylene glycol, liposomes, sugars, gelatin, lactose, amylose, magnesium stearate, talc, surfactants, silicic acid, viscous paraffin, perfume oil, fatty acid monoglycerides and diglycerides, petroethral fatty acid esters, hydroxymethyl-cellulose, polyvinylpyrrolidone, and the like.

In one embodiment, the feed additive composition is formulated to a dry powder or granules as described in WO2007/044968 (referred to as TPT granules) or WO 1997/016076 or WO 1992/012645 (each of which is incorporated herein by reference).

In one embodiment, the feed additive composition may be formulated to a granule feed composition comprising: one or more of the fat-coated granules (such as fat-coated enzyme granules) disclosed herein. In one embodiment, the active agent of the granule retains activity after processing. In one embodiment, the active agent of the granule retains an activity level after processing selected from the group consisting of: 50-60% activity, 60-70% activity, 70-80% activity, 80-85% activity, 85-90% activity, and 90-95% activity.

In yet another embodiment, the granule may be produced using a feed pelleting process and the feed pretreatment process may be conducted between 70° C. and 95° C. for up to several minutes, such as between 85° C. and 95° C. In another embodiment, the granule may be produced using a steam-heated pelleting process that may be conducted between 85° C. and 95° C. for up to several minutes.

In one embodiment, the granule may have a moisture barrier coating selected from polymers and gums and the moisture hydrating material may be an inorganic salt. The moisture hydrating coating may be between 25% and 45% w/w of the granule and the moisture barrier coating may be between 2% and 20% w/w of the granule.

In one embodiment, the active agent retains activity after conditions selected from one or more of: (a) a feed pelleting process; (b) a steam-heated feed pretreatment process; (c) storage; (d) storage as an ingredient in an unpelleted mixture; and (e) storage as an ingredient in a feed base mix or a feed premix comprising at least one compound selected from trace minerals, organic acids, reducing sugars, vitamins, choline chloride, and compounds which result in an acidic or a basic feed base mix or feed premix.

In some embodiments, the feed additive compositions may be diluted using a diluent, such as starch powder, lime stone or the like. In one embodiment, the fat-coated enzymes may be in a liquid formulation suitable for consumption. In some embodiments, such liquid consumption contains one or more of the following: a buffer, salt, sorbitol and/or glycerol. In another embodiment, the feed additive composition may be formulated by applying, e.g. spraying, the enzyme(s) onto a carrier substrate, such as ground wheat for example.

In one embodiment, the feed additive composition may be formulated as a premix. By way of example only, the premix may comprise one or more feed components, such as one or more minerals and/or one or more vitamins.

In another embodiment, the feed additive composition can be delivered as an aqueous suspension and/or an elixir. The feed additive composition may be combined with various sweetening or flavoring agents, coloring matter or dyes, with emulsifying and/or suspending agents and with diluents such as water, propylene glycol and glycerin, and combinations thereof.

G. Feedstuffs

In another embodiment, provided herein are feed additive compositions containing any of the fat-coated enzyme-containing compositions disclosed herein that may be used as a feed or in the preparation of a feed. The feed may be in the form of a solution or as a solid depending on the use and/or the mode of application and/or the mode of administration. When used as a feed or in the preparation of a feed, such as functional feed, the feed additive composition may be used in conjunction with one or more of the following: a nutritionally acceptable carrier, a nutritionally acceptable diluent, a nutritionally acceptable excipient, a nutritionally acceptable adjuvant, a nutritionally active ingredient.

In one embodiment, the feed additive composition disclosed herein is admixed with a feed component to form a feedstuff. In one embodiment, the feed may be a fodder, or a premix thereof, a compound feed, or a premix thereof. In one embodiment, the feed additive composition disclosed herein may be admixed with a compound feed, a compound feed component or a premix of a compound feed or to a fodder, a fodder component, or a premix of a fodder.

In one embodiment, fodder may be obtained from one or more of the plants selected from: alfalfa (lucerne), barley, birdsfoot trefoil, brassicas, Chau moellier, kale, rapeseed (canola), rutabaga (swede), turnip, clover, alsike clover, red clover, subterranean clover, white clover, grass, false oat grass, fescue, Bermuda grass, brome, heath grass, meadow grasses (from naturally mixed grassland swards, orchard grass, rye grass, Timothy-grass, corn (maize), millet, oats, sorghum, soybeans, trees (pollard tree shoots for tree-hay), wheat, and legumes.

Compound feeds can be complete feeds that provide all the daily required nutrients, concentrates that provide a part of the ration (protein, energy) or supplements that only provide additional micronutrients, such as minerals and vitamins. The main ingredients used in compound feed are the feed grains, which include corn, soybeans, sorghum, oats, and barley.

In one embodiment, a feedstuff as disclosed herein may comprise one or more feed materials selected from the group comprising cereals, such as small grains (e.g., wheat, barley, rye, oats and combinations thereof) and/or large grains such as maize or sorghum; by products from cereals, such as corn gluten meal, Distillers Dried Grain Solubles (DDGS), wheat bran, wheat middlings, wheat shorts, rice bran, rice hulls, oat hulls, palm kernel, and citrus pulp; protein obtained from sources such as soya, sunflower, peanut, lupin, peas, fava beans, cotton, canola, fish meal, dried plasma protein, meat and bone meal, potato protein, whey, copra, sesame; oils and fats obtained from vegetable and animal sources; and minerals and vitamins.

In yet another embodiment, a feedstuff may comprise at least one high fiber feed material and/or at least one by-product of the at least one high fiber feed material to provide a high fiber feedstuff. Examples of high fiber feed materials include: wheat, barley, rye, oats, by products from cereals, such as corn gluten meal, Distillers Dried Grain Solubles (DDGS), wheat bran, wheat middlings, wheat shorts, rice bran, rice hulls, oat hulls, palm kernel, and citrus pulp. Some protein sources may also be regarded as high fiber: protein obtained from sources such as sunflower, lupin, fava beans and cotton

In still another embodiment, the feed may be one or more of the following: a compound feed and premix, including pellets, nuts or (cattle) cake; a crop or crop residue: corn, soybeans, sorghum, oats, barley, corn stover, copra, straw, chaff, sugar beet waste; fish meal; freshly cut grass and other forage plants; meat and bone meal; molasses; oil cake and press cake; oligosaccharides; conserved forage plants: hay and silage; seaweed; seeds and grains, either whole or prepared by crushing, milling etc.; sprouted grains and legumes; yeast extract.

In one embodiment, the feed additive composition of disclosed herein is admixed with the product (e.g. feedstuff). Alternatively, the feed additive composition may be included in the emulsion or raw ingredients of a feedstuff. In another embodiment, the feed additive composition is made available on or to the surface of a product to be affected/treated. In still another embodiment, the feed additive compositions disclosed herein may be applied, interspersed, coated and/or impregnated to a product (e.g. feedstuff or raw ingredients of a feedstuff) with a controlled amount of one or more fat-coated enzymes.

### III. Methods

A. Methods for Manufacturing Coated Granules

Also provided herein are methods for manufacturing a coated enzyme granule comprising either a)(i) mixing the enzyme and carrier with a molten coating material comprising a fat (such as any of the fats discussed supra); and (ii) granulating by rapidly decreasing the temperature of the mixture; or b) enrobing the enzyme and carrier with one or more layers (such as any of 1, 2, 3, 4, 5, 6, 7, 8, 9, 10, or more) of a fat coating material built up under a controlled spraying and cooling regime, wherein the enzyme maintains at least about 50% residual activity after being cooled.

Powdery or granulated enzyme or feed supplements (including carriers comprising one or more proton acceptors) can be mixed with molten fat and atomized by spray cooling, chilling, or spray freezing. In spray-cooling/chilling, a slurry of molten lipid (fat or emulsifier) and particles (e.g. organic and inorganic salts, enzymes, spray-dried flavors, etc.) is atomized into a stream of ambient or refrigerated air or gas. The temperature of the air stream is well below the solidification point of the lipid phase, so that the liquid droplets solidify in the air-stream as the lipid crystallizes, forming particles with a matrix structure. The slurry can be atomized using a rotating wheel or a two-fluid or pressure nozzle, depending on the particle size required in the final powder. This process can be referred to spray-crystallization (general reference), spray-cooling, spray-chilling (cooling air stream is ambient or chilled air) and spray-freezing (cooling air stream temperature is below zero).

Powdery or granulated enzyme or feed supplements (including carriers comprising one or more proton acceptors) can also be mixed with molten fat and coated in a fluid-bed by hot-melt coating. In hot melt fluid bed coating the core particles are suspended in an upward-moving air stream in a fluidized-bed chamber, where the air temperature and humidity are controlled. Due to the configuration of the fluidized bed chamber, the coated particles move upwards in the center of the bed, before decelerating and falling as they reach the outer edge of the bed. The coating material—melted lipid (fat or emulsifier)—is atomized from a nozzle onto the core particles. The spray nozzle may be either situated above the bed of suspended particles (countercurrent, top spray mode), or at the bottom of the bed (co-current, bottom-spray (Wurster) mode). The atomized coating material is deposited onto the core particles as a thin layer, which solidifies in cool air. Due to the random orientation of the core particles, a uniform coating is built up slowly from the thin, overlapping layers of coating material. The amount of coating applied is controlled by the time the particles are in the chamber.

In some embodiments, the enzyme and carrier is mixed with the molten coating material (such as a fat) at temperatures less than about 90° C. (such as less than about any of 89° C., 88° C., 87° C., 86° C., 85° C., 84° C., 83° C., 82° C., 81° C., 80° C., 79° C., 78° C., 77° C., 76° C., 75° C., 74° C., 73° C., 72° C., 71° C., or 70° C. In other embodiments, the fat has a melting point of about 40-80° C., such as any of 40° C., 45° C., 50° C., 55° C., 60° C., 65° C., 70° C., 75° C., or 80° C., inclusive of all values falling in between these numbers. In yet further embodiments, the enzyme and carrier is mixed with a molten coating material for at least about two hours, such as at least about 30 mins, 45 mins, 60 mins, 75 mins, 90 mins, 105 mins, or 120 mins, inclusive of all values in between these times. In yet further embodiments, the enzyme and carrier are suspended in a heated air stream, and spray-coated with the molten coating material which forms a multiplicity of overlapping layers (such as any of 1, 2, 3, 4, 5, 6, 7, 8, 9, 10, or more) of fat around the core material.

When spray cooling is employed, cooling temperatures from about 15-40° C. (such as any of about 15° C., 20° C., 25° C., 30° C., 35° C., or 40° C., inclusive of all values falling in between these temperatures) are used. When chilling is employed, cooling temperatures from about 0-15° C. (such as any of about 0° C., 1° C., 2° C., 3° C., 4° C., 5° C., 6° C., 7° C., 8° C., 9° C., 10° C., 11° C., 12° C., 13° C., 14° C. or 15° C.) are used. When spray freezing is employed, cooling temperatures in the negative ° C. range, such as from about −1 to −100° C. (for example, any of about −5° C., −10° C., −15° C., −20° C., −25° C., −30° C., −40° C., −45° C., −50° C., −55° C., −60° C., −65° C., −70° C., −75° C., −80° C., −85° C., −90° C., −95° C., −100° C., or lower, inclusive of all values falling in between these temperatures) are used. The hot-melt coating procedure can also be carried out using fluidized bed technology as described by Desai and Park. (Journal of Food Engineering 2002. 53:325-340; Drying Technol. 2005. 23:1361-1394, incorporated by reference herein). Other references describing this technology can be found in U.S. Pat. No. 6,423,517, WO2001/083727, and Teunou and Poncelet, 2002, J. Food Engineer., 53:325-40, incorporated by reference herein.

In some embodiments, the dried supplement has a moisture content less than about 15% such as any of less than about 14%, 13%, 12%, 11%, 10%, 9%, 8%, 7%, 6%, 5%, 4%, 3%, 2%, or 1%.

In further embodiments, the fat-coated granules (such as fat-coated enzyme granules) have a particle size range of 100-1500 μm or 500-1500 μm in diameter, such as about 580-1466 μm, such as any of about 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, 1000 μm, 1050 μm, 1100 μm, 1150 μm, 1200 μm, 1250 μm, 1300 μm, 1350 μm, 1400 μm, 1450 μm, or 1500 μm, in diameter inclusive of all values falling in between these numbers.

In other embodiments, the granules or the dried form of the granules have a particle density of about 0.6-1.2 g/cm³ (equivalent to g/mL) or 0.7-2.0 g/cm³ (such as any of about 0.6 g/cm³, 0.7 g/cm³, 0.8 g/cm³, 0.9 g/cm³, 1 g/cm³, 1.1 g/cm³, 1.2 g/cm³, 1.3 g/cm³, 1.4 g/cm³, 1.5 g/cm³, 1.6 g/cm³, 1.7 g/cm³, 1.8 g/cm³, 1.9 g/cm³, or 2 g/cm³). In further embodiments, the granules or the dried form of the granules have a density of about 0.6-1.3 g/ml, such as any of about 0.6 g/ml, 0.7 g/ml, 0.8 g/ml, 0.9 g/ml, 1 g/ml, 1.1 g/ml, 1.2 g/ml, or 1.3 g/ml.

The granule of any of the embodiments disclosed herein can contain from about 30% to about 70% (w/w) fat content, such as about 40% to 60% (w/w), or 45% to 55% (w/w), such as any of about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% (w/w) fat content. In some embodiments the fat is a plant fat, for example, palm oil.

The granule of any of the embodiments disclosed herein can contain from about 10% to about 30% (w/w) carrier content, such as 15% to 25% (w/w), such as any of about 10%, 11%, 12%, 13%, 14%, 15%, 16%, 17%, 18%, 19%, 20%, 21%, 22%, 23%, 24%, 25%, 26%, 27%, 28%, 29%, or 30% (w/w) carrier content. In some embodiments the carrier contains, comprises, or is calcium chloride or limestone.

The granule of any of the embodiments disclosed herein can further contain from about 10% to about 40% (w/w), such as about 15% to 35% (w/w), 20% to 30% (w/w) active agent (such as an enzyme) content, such as any of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% (w/w) active agent (such as an enzyme) content. In some non-limiting embodiments, the active agent is an enzyme (such as a glucoamylase).

In further embodiments, the fat-coated granules (such as fat-coated enzyme granules) have a particle size range of 500-1500 μm, such as about 100 μm, 200 μm, 300 μm, 400 μm, 500 μm, or 580-1466 μm, such as any of about 100 μm, 200 μm, 300 μm, 400 μm, 500 μm, 550 μm, 600 μm, 650 μm, 700 μm, 750 μm, 800 μm, 850 μm, 900 μm, 950 μm, 1000 μm, 1050 μm, 1100 μm, 1150 μm, 1200 μm, 1250 μm, 1300 μm, 1350 μm, 1400 μm, 1450 μm, or 1500 μm, inclusive of all values falling in between these numbers.

In some embodiments, the coated enzymes deliver about 50%-90% (such as any of about 55%, 60%, 65%, 70%, 75%, 80%, 85%, or 90%, inclusive of all values falling in between these percentages) of enzyme activity to the small intestine of a ruminant animal. In other embodiments, the enzyme maintains at least about 50%, about 55%, about 60%, about 65%, about 70%, about 75%, about 80%, about 85%, about 90%, about 95%, or about 100% residual activity after being coated, inclusive of all values falling in between these percentages. In other embodiments, the enzyme maintains at least about 60%, about 65%, about 70%, about 75%, about 80%, about 85%, about 90%, about 95%, or about 100% residual activity in conditions that simulate the rumen environment (such as in 0.1M MES—NaOH buffer at pH 6.0 and 40° C. with a shaking speed of 215 rpm) for up to 24 hours (such as any of 1, 2, 3, 4, 5, 6, 7, 8, 9, 10, 11, 12, 13, 14, 15, 16, 17, 18, 19, 20, 21, 22, 23, or 24 hours).

Additionally, the methods for preparing a feed additive composition can further include combining the feed additive composition with one or more DFMs, with betaine, and/or with one or more essential oils. The method can additionally include a further step of packaging the feed additive composition for storage or transport.

B. Methods for Improving Performance Metrics in an Animal

Further provided herein are methods for increasing performance metrics of an animal. In another embodiment, the disclosure relates to methods of increasing performance metrics of a bird. In still another embodiment, the disclosure relates to methods of increasing performance metrics of poultry, including but not limited to broilers, chickens and turkeys.

In yet another embodiment, the disclosure relates to a method comprising administering to an animal a feed or feed additive composition comprising one or more fat-coated enzymes (such as any of the fat-coated enzymes disclosed herein). In still another embodiment, the disclosure relates to a method comprising administering to an animal an effective amount of a composition comprising one or more fat-coated enzymes (such as any of the fat-coated enzymes disclosed herein) to increase performance of the animal. This effective amount can be administered to the animal in one or more doses. In one embodiment, the animal is a ruminant.

In another embodiment, the disclosure relates to a method comprising administering to an animal (such as a ruminant, for example a beef or dairy cow) an effective amount of a composition comprising one or more fat-coated enzymes (such as any of the fat-coated enzymes disclosed herein) to increase average daily feed intake. In some embodiments, the average daily feed intake increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered one or more of the fat-coated enzyme-containing compositions disclosed herein. In some embodiments, the composition is a feed additive composition. In other embodiments, the composition is a feed or feedstuff.

In another embodiment, the disclosure relates to a method comprising administering to an animal (such as a ruminant, for example a beef or dairy cow) an effective amount of a composition comprising one or more fat-coated enzymes (such as any of the fat-coated enzymes disclosed herein) to increase average daily weight gain. In some embodiments, the average daily weight gain increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered one or more of the fat-coated enzyme-containing compositions disclosed herein. In some embodiments, the composition is a feed additive composition. In other embodiments, the composition is a feed or feedstuff.

In another embodiment, the disclosure relates to a method comprising administering to an animal (such as a ruminant, for example a beef or dairy cow) an effective amount of a composition comprising one or more fat-coated enzymes (such as any of the fat-coated enzymes disclosed herein) to increase total weight gain. In some embodiments, total weight gain increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered one or more of the fat-coated enzyme-containing compositions disclosed herein. In some embodiments, the composition is a feed additive composition. In other embodiments, the composition is a feed or feedstuff.

In another embodiment, the disclosure relates to a method comprising administering to an animal (such as a ruminant, for example a beef or dairy cow) an effective amount of a composition comprising one or more fat-coated enzymes (such as any of the fat-coated enzymes disclosed herein) to increase feed conversion, which can be measured by either feed:gain or gain:feed. In some embodiments, feed conversion increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered one or more of the fat-coated enzyme-containing compositions disclosed herein. In some embodiments, the composition is a feed additive composition. In other embodiments, the composition is a feed or feedstuff.

In another embodiment, the disclosure relates to a method comprising administering to an animal (such as a ruminant, for example a beef or dairy cow) an effective amount of a composition comprising one or more fat-coated enzymes (such as any of the fat-coated enzymes disclosed herein) to increase feed efficiency. In some embodiments, feed efficiency increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages relative to animals who are not administered one or more of the fat-coated enzyme-containing compositions disclosed herein. In some embodiments, the composition is a feed additive composition. In other embodiments, the composition is a feed or feedstuff.

In another embodiment, the disclosure relates to a method comprising administering to an animal (such as a ruminant, for example a beef or dairy cow) an effective amount of a composition comprising one or more fat-coated enzymes (such as any of the fat-coated enzymes disclosed herein) to decrease feed conversion ratio (FCR). In some embodiments, FCR decreases by any of about 10%, 15%, 20%, 25%, 30%, 35%, 40%, 45%, 50%, 55%, 60%, 65%, 70%, 75%, 80%, 85%, 90%, 95%, or 100%, inclusive of all values falling in between these percentages, relative to animals who are not administered one or more of the fat-coated enzyme-containing compositions disclosed herein. In some embodiments, the composition is a feed additive composition. In other embodiments, the composition is a feed or feedstuff.

In another embodiment, the disclosure relates to a method comprising administering to an animal (such as a ruminant, for example a dairy cow) an effective amount of a composition comprising one or more fat-coated enzymes (such as any of the fat-coated enzymes disclosed herein) to increase milk production. In some embodiments, milk production increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages relative to animals who are not administered one or more of the fat-coated enzyme-containing compositions disclosed herein. In some embodiments, the composition is a feed additive composition. In other embodiments, the composition is a feed or feedstuff.

The composition comprising fat-coated enzymes may be administered to the animal in one of many ways. For example, the composition can be administered in a solid form as a veterinary pharmaceutical, may be distributed in an excipient. In other embodiments, the composition can be administered as a drench, formulated with a liquid oil phase, incorporating the fat-coated granule. In further embodiments, the composition can be administered as a paste. In some embodiments, water, and directly fed to the animal, may be physically mixed with feed material in a dry form, or the composition may be formed into a solution and thereafter sprayed onto feed material. The method of administration of the compositions disclosed herein to the animal is considered to be within the skill of the artisan.

When used in combination with a feed material, the feed material can include corn, soybean meal, byproducts like distillers dried grains with solubles (DDGS), and vitamin/mineral supplement. Other feed materials can also be used.

Thus, in at least some embodiments, the effective amount of the composition comprising fat-coated enzymes is administered to an animal by supplementing a feed intended for the animal. As used herein, “supplementing,” refers to the action of incorporating the effective amount of fat-coated enzymes herein directly into the feed intended for the animal. Thus, the animal, when feeding, ingests the fat-coated enzymes provided herein.

The invention can be further understood by reference to the following examples, which are provided by way of illustration and are not meant to be limiting.

### EXAMPLES

### Example 1: Preparation and Characterization of Fat-Coated Aspergillus fumigatus Glucoamylase

This example describes the preparation and characterization of fat-coated enzymes.

Enzyme preparation: A glucoamylase ultrafiltration concentrate (NAP2019-0051) containing the glucoamylase from Aspergillus fumigatus (SEQ ID NO:1) derived from expression in Trichoderma reesei (WO2018057420, incorporated by reference herein) was first spray dried, then fat coated, followed by testing for activity recovery after coating and granulation. The concentrate had a pH of 4.5, specific gravity of 1.097 g/ml; a sodium benzoate of 0.31% and a potassium sorbate of 0.1%, a total protein and solids about 301.9 mg/ml where the enzyme protein was about 129.94 mg/g.

Spray drying: Primary enzyme particles were produced by spray-drying the enzyme preparation NAP2019-0051 using a Niro 6.3 spray tower, equipped with rotary atomizer (Ø 120 mm). Two different formulations (NAP2019-0051-1 and NAP2019-0051-2) were made for spray drying (Table 5) and tested different carrier materials: Calcium Carbonate (CALFORT®5, Reverté, Barcelona, Spain) was chosen due to its high particle density and its capability of acting as proton acceptor, whereas fumed silica (SIPERNAT® 25, Evonik, Hanau, Germany) was selected due to its high surface area.

TABLE 5
Composition of spray dried A. fumigatus GA particles.

| Sample ID | NAP2019-0051-1 | NAP2019-0051-2 |
|---|---|---|
| Amount Enzyme | 2000 | 2000 |
| Concentrate (g) | | |
| Amount Calcium | 260 | — |
| Carbonate (g) | | |
| Amount Silica (g) | — | 130 |

For both formulations, the carrier material was added to the enzyme concentrate and dispersed with a high-shear mixer, just prior to spraying. The enzyme-carrier slurry was then spray-dried under the conditions given in Table 6, with constant agitation during spraying, to ensure a homogeneous product.

TABLE 6
Preparation of spray dried A. fumigatus GA particles.

| Sample | NAP2019-0051-1 | NAP2019-0051-2 |
|---|---|---|
| Batch Size (g) | 2260 | 2130 |
| Wheel Speed (rpm) | 18000 | 18000 |
| Process Air Temperature, | 160 | 160 |
| Inlet (° C.) | | |
| Process Air Temperature, | 88-89 | 89-91 |
| Outlet (° C.) | | |
| Product moisture (w/w %) | 3.67 | 4.32 |

The fat coating process: Two different approaches were tested for matrix coating the primary particles obtained in the spray drying procedure above, both of which involved forced cooling of a slurry of primary particles and fully hardened palm oil. The proportion of primary particles was held constant at 30% w/w relative to the oil.

Fat coated sample NAP2019-0074-1 was prepared by spray-crystallization of the slurry, in a Niro 6.3 spray tower. Fully hardened palm oil (1167 g) was melted in a water bath, and heated until 80° C. The primary particles (sample NAP2019-0051-1; 500 g) were added and the slurry mixed with a high-shear mixer to disperse the powder. The slurry was pumped to a two-fluid nozzle and sprayed into the tower. The process parameters are as follows in Table 7.

TABLE 7
Process parameters for preparation of
spray dried A. fumigatus GA particles.

| | |
|---|---|
| Nozzle Tracing (° C.) | 75 |
| Inlet Air Temperature (° C.) | 11 |
| Outlet Air Temperature (° C.) | 14 |
| Feed rate (kg hr⁻¹) | 16.875 |
| Atomizing Air Flow (l s⁻¹) | 4.5 |
| Atomizing Air Temperature, Nozzle (° C.) | 200 |

The fat coated sample NAP2019-0074-2 was prepared by force-cooling the slurry in a high-shear mixer, filled with dry ice. The 210 g of full hardened palm oil was heated to 75° C. 90 g of spray dried primary particles (NAP2019-0051-2) was added and dispersed using a high-shear mixer, to give a smooth slurry. The slurry was slowly poured into the high-shear mixer and mixing was continued for a total of 5 min. The product was left in the mixer until all dry ice had evaporated and the powder was at room temperature. The product was fractionated into 3 size classes as shown in Table 8. From Table 8 it can be seen that the recovery of spray-dried dried A. fumigatus GA with calcium carbonate as carrier was from 67.5% to 71.2%. After 2 h of incubation for bigger granules (>1400 μm), 27.1% of activity was released to the aqueous phase (0.1M Mes pH6.0). Smaller sized granules tended to release more activity to the aqueous phase.

TABLE 8
Fractionation of NAP2019-0074 A. fumigatus GA spray dried particles.

| | | | | Activity |
|---|---|---|---|---|
| | | | Activity | released (%) at |
| | Sieve | | recovery | pH6.0 and |
| | Size | Amount | (%) after fat | 40° C. |
| Sample ID | (μm) | (g) | coating | for 2 h |
| NAP2019-0074-2-i | >1400 | 41 | 69.9 | 27.1 |
| NAP2019-0074-2-ii | 500-1400 | 133 | 67.5 | 58.4 |
| NAP2019-0074-2-iii | <500 | 103 | 71.2 | 98.1 |

Assay of glucoamylase activity recovery in fat-coated granule and of glucoamylase activity release: The granules (1.0 g) were ground with a mixer (Analysenmiihle A10 from IKA®-Werke GmbH & Co. KG, Staufen, Germany) for 2×15 seconds, suspended and extracted in 50 ml 0.1M of sodium acetate pH4.5 containing 5 mM calcium chloride and 0.05% (w/w) Tween 80 at 50° C. for 15 min. The supernatant (i.e., the aqueous phase) was assayed using glycogen as a substrate and released glucose was determined colorimetrically by using a D-glucose assay kit (GOPOD Format, K-GLUC) from Megazyme Inc. For assessing the stability of the fat-coated granules, the granules (0.2 g) were suspended in 10 ml of 0.1M MES buffer pH6.0 and incubated at 40° C. for 2 h. After 2 h incubation, the mixture was diluted with 0.1M of sodium acetate pH4.5 and glucoamylase activity in the aqueous phase was assayed for glucose release quantified as above using the glucose assay kit. The assay used glycogen as a substrate. For control, the granules (0.20 g) were ground with the mixer, suspended and extracted in 10 ml 0.1M of sodium acetate pH4.5 containing 5 mM calcium chloride (0.05% (w/w)). The activity in the extracted aqueous phase of the control was determined and was used as 100%.

Fat coated sample NAP2019-0074-1 had an activity recovery of 70.7% after the fat coating process. The percent enzyme activity release (%) observed for pH6.0 and 40° C. for 2 h conditions was 86.1. That is, there was still some 14% remaining enzyme protected by the fat coating after 2 hours.

The activity recovery and percent enzyme activity release of sample NAP2019-0074-2 is shown in Table 8.

### Example 2: Preparation and Characterization of Fat-Coated Aspergillus niger and Trichoderma reesei Glucoamylases by Matrix Coating Process

Fat coated particles were prepared containing a glucoamylase. Palm oil (neutralized bleached hydrogenated palm oil 58) was obtained from Cargill (CZ Schiphol, The Netherlands). The solid fat has a melting point 55-60° C. and a relative density of 0.92-0.98 at 20° C. according to the manufacturer. The palm oil (7 parts by weight) was melted by heating to >80° C. and then mixed with 3 parts (by weight) of either spray-dried glucoamylase from Aspergillus niger (AMG® 1100 BG, Novozymes, Denmark, sequence reference: NCBI accession number is XP_001390530.1, SEQ ID NO:2) resulting in samples Fla0212, Fla0213, Fla0214 and Fla0215 or co-spray-dried (by spray-crystallization) glucoamylase (from Trichoderma reesei (SEQ ID NO:3)) and limestone (40% w/w, Omya Nutricarb 40-SL (Omya SAS France) containing 98% CaCO₃ with density 2.7 g/ml) resulting in sample Dam001. The oil and dried enzyme preparation having a moisture less than 4% (w/w) were mixed to give a homogeneous slurry of enzyme powder in oil. The slurry was mixed continuously at 70° C. for about 30 min, 45 min and 90 min, or 80° C. for 120 min, followed by spray crystallization through a nozzle into a stream of cold air to rapidly cool the suspension below the melting point of the fat so that it solidified and granulated.

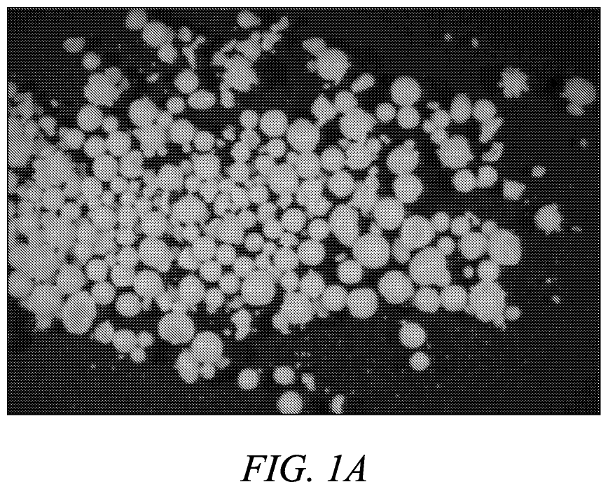

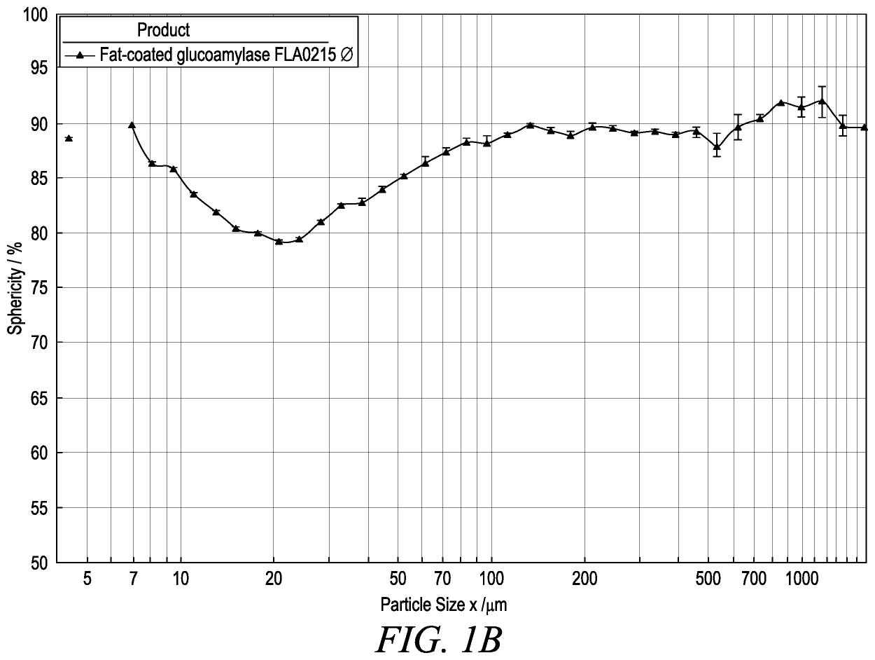

The coated products using glucoamylase from A. niger were designated as samples Fla0212, 213, 214, prepared using different incubation times in the production process (described on Table 10) and sample designated sample Fla0215 was a mixture of the three (samples Fla0212, 213, 214). Unless otherwise stated, sample Fla0215 was used for the subsequent characterizations (data shown on Table 9, FIGS. 1A, and 1B). A stereo microscopy photo of the Fla0215 granules obtained is shown in FIG. 1A, the roundness or sphericity is provided in FIG. 1B. Images on FIG. 1A and FIG. 1B, show that the particles were highly spherical (above 80%).

The particle size distribution for samples prepared with Aspergillus niger GA (sample Fla0215) is summarized in Table 9. The volume mean diameter is 816 μm; 10% of the particles are below 356 μm and 90% of the particles are below 1225 μm in size. The bulk density of the particles was calculated by weighing a known volume (100 ml) of the fat coated granules.

TABLE 9
Summary of particle size distribution for sample Fla0215

| | Volume | | | | | |
|---|---|---|---|---|---|---|
| | Mean | | | | | |
| | Particle | | | | | Bulk |
| | Size, | D10 | D50 | D90 | Span | Density |
| Sample | (μm) | (μm) | (μm) | (μm) | (—) | (gl⁻¹) |
| Fla0215 | 816 | 356 | 846 | 1225 | 1.03 | 637 |

The fat coated A. niger glucoamylase was further evaluated for residual activity after mixing with melting fat at 70° C. and 80° C. followed by spraying. Given that enzymes are polypeptides, it would have been expected that significant enzyme inactivation would have resulted from exposure to such raised temperatures for prolonged time in the presence of a hydrophobic solvent (melted oil in the current case) or environment. However, it was surprisingly found that the activity recovery for the glucoamylase from A. niger was over 87% when mixed with the oil for a time of from 30 to 90 min (Table 10).

TABLE 10
Aspergillus niger glucoamylase activity recovery
for fat-coated samples. Glucoamylase activity
was assayed as described in Example 1.

| Glucoamylase | Incubation | Activity |
|---|---|---|
| preparation No. | time (min) | recovery, % |
| Fla0212 | 30 | 96.5 |
| Fla0213 | 45 | 92.9 |
| Fla0214 | 90 | 87.3 |

The fat coated glucoamylase preparation was also tested for solution stability. As shown in Table 11, after 2 h incubation at 40° C. with shaking at 215 rpm, there is still some 60% activity unreleased from the granule and after 5 h incubation some 45 to 50% of the enzyme activity remained unreleased or protected by the fat coating.

Table 11 shows stability of fat coated Aspergillus niger glucoamylase (sample F1a0215) at 40° C. in 0.1 M MES-NaOH pH6.0 with shaking at 215 rpm. Samples of 0.2-0.25 g were suspended in 10 ml the MES buffer (pH 6.0) in 13 ml plastic tubes and shaken horizontally. Aliquots were taken out at 0, 1, 2, 3, and 5 h for glucose release activity measurement as described in Example 1 after centrifugation at 3500 rpm for 5 min to obtain the supernatant or the aqueous phase having the released GA enzyme. GA activity for samples of 0.2-0.25 g suspended in 0.1 M acetate (pH 4.5) having 5 mM CaCl₂, 0.05% (w/w) Tween 80 pH 4.5 is regarded as 100%.

TABLE 11
Stability of fat coated Aspergillus niger glucoamylase
measured by glucose release activity in the
aqueous phase, at the time intervals indicated.

| Enzyme | | | | | |
|---|---|---|---|---|---|
| preparation | 0 h | 1 h | 2 h | 3 h | 5 h |
| Fla0212 | 7.9 | 29.0 | 38.2 | 44.8 | 50.1 |
| Fla0213 | 6.1 | 27.2 | 36.0 | 42.1 | 50.4 |
| Fla0214 | 7.2 | 29.4 | 39.2 | 45.5 | 55.5 |

When the glucoamylases were mixed with the oil at 80° C. for 120 min, it was surprisingly found that the activity recovery for both the A. niger and T. reesei enzymes were over 50% (Table 12). Note that the recovery is lower when sample was mixed at 80° C. with the melted fat instead of 70° C. (data on Table 10) for the same glucoamylase (A. niger GA).

TABLE 12
Glucoamylase activity recovery after mixing with melting oil
at 80° C. for 2 h. followed by granulation. GA activity
from the granules was compared to the activity of
enzyme powder which was regarded as having 100% activity.

| | Glucoamylase | |
|---|---|---|
| Sample ID | sequence origin | Activity recovery, % |
| Fla0187 | Trichoderma reesei | 81.0 |
| Fla0188 | Aspergillus niger | 79.0 |
| Fla0192 | Aspergillus niger | 63.6 |

### Example 3: Preparation of Limestone and Fat-Coated Trichoderma reesei Glucoamylases by Hot-Melt Fluid Bed Coating Process

A sample of Trichoderma reesei glucoamylase ultrafiltrated concentrate was first co-spray-dried onto feed grade limestone as carrier (98% CaCO₃, density of 2.7 g/ml, Omya Nutricarb 40-SL limestone, Omya SAS France). The resulting spray-dried product had a moisture content of 3.94%. The spray-dried glucoamylase limestone was hot-melt coated with fully hardened palm oil (GRINDSTED® PS 101 MB, melting point approximately 60° C.) in a fluid bed operating in top-spray mode and using a two-fluid nozzle to atomize the coating material. Trial conditions are given below in Table 13). Three batches were prepared with increasing amounts of coating: 40% w/w (Dam004), 50% w/w (Dam005) and 60% w/w (Dam006).

TABLE 13
Process parameters for hot-melt fluid bed coating of
co-spray-dried glucoamylase-limestone granules

| Parameter | Set-point |
|---|---|
| Fluid bed | Aeromatic MP1 |
| Amount co-spray-dried | 1.8-2 |
| glucoamylase and limestone (kg) | |
| Amount fully hardened palm oil (kg) | 1.2 (40%)-1.8 (50%)-2.7 (60%) |
| Product Temperature (° C.) | 44-46 |
| Fluidizing Air Flow (m³hr⁻¹) | 50-65 |
| Atomising Air Temperature (° C.) | 90 |
| Atomizing Air Pressure (bar) | 1.4-1.6 |
| Spray Rate (kghr⁻¹) | 0.8-1.2 |

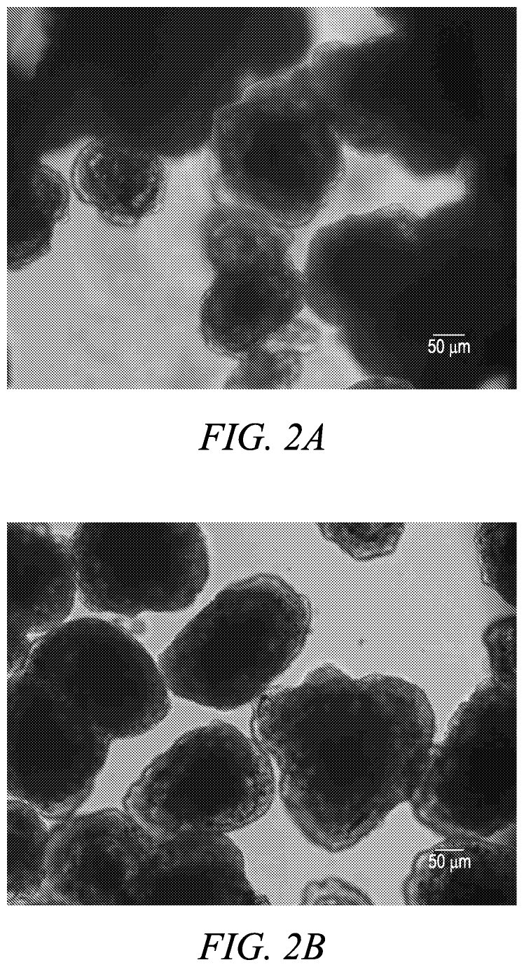

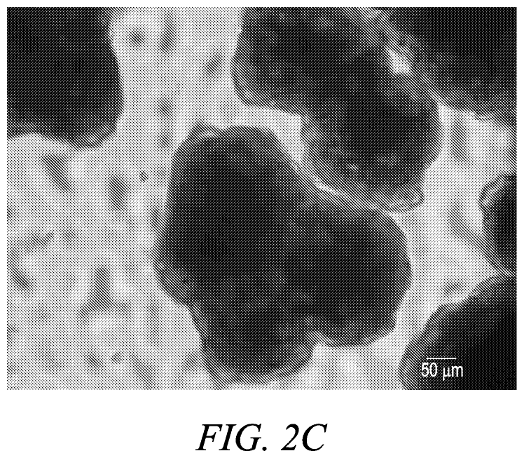

Representative light microscope photographs for samples from these three batches are shown in FIGS. 2A, 2B, and 2C, respectively. The continuous fat coating is clearly seen surrounding the core particle.

Table 14 describes the physical properties of these 3 samples. In these examples the core comprises the co-spray-dried calcium carbonate (limestone) glucoamylase particles, which are completely surrounded by multiple overlapping layers of fat-coating. Without being bound to theory, it is believed that calcium carbonate reacts with and neutralizes protons that diffuse from outside, thus better protecting the enzyme from inactivation at low pH. This process is described in FIG. 3.

TABLE 14
Physical properties of fat coated Trichoderma reesei
glucoamylase enzyme obtained by hot-melt fluid bed coating.

| | Amount of | Geometric Average | | |
|---|---|---|---|---|
| | Coating | Particle Size, | Span | Bulk Density |
| Sample | (% fat) | D50 (μm) | (-) | (gl⁻¹) |
| Dam004 | 40 | 268 | 0.95 | 620 |
| Dam005 | 50 | 314 | 0.97 | 637 |
| Dam006 | 60 | 322 | 0.83 | 596 |

FIG. 3 shows a graphic depiction of granule composition for matrix coated versus fluidized bed coated samples. For reference, Dam001 was prepared by matrix coating, and Dam004, Dam005 and Dam006 were prepared by fluidized bed coating. The principle of having limestone inside the enzyme core and a fat layer outside is to allow the neutralization of protons by calcium carbonate, the major component of the limestone as shown in FIG. 3, in addition to its other roles as a carrier in the granule manufacturing process and as a means to increase the particle density of the granules, thereby facilitating more rapid transit through the rumen.

The fat-coated granules with or without various amounts of limestone were prepared by Bewital (SUdlohn, Germany) (sample F1a0215, Dam001) or by Innov'ia (La Rochelle, France) (samples Dam004, Dam005 and Dam006). The bulk density of the fat-coated granules was measured by weighing a known volume of granules in a graduated cylinder for volume to get a weight-volume ratio. Table 14 shows the bulk density measurements for the fat coated glucoamylase enzymes. Clearly, increasing the fat content decreased the bulk density of granules whereas increasing the limestone content resulted in increased granule density.

TABLE 14
Density estimation of limestone and
fat coated glucoamylase enzyme granules

| | | | | | | Bulk |
|---|---|---|---|---|---|---|
| | | Amount | Amount | Amount | | Den- |
| Sample | | fat | enzyme | limestone | Coated | sity |
| ID | Enzyme | (%) | (%) | (%) | by | (kg/l) |
| Fla0215 | Aspergillus | 70 | 30 | 0 | Spray- | 635.8 |
| | niger | | | | crystal- | |
| | gluco- | | | | lization | |
| | amylase | | | | | |
| Dam001 | Trichoderma | 70 | 18 | 12 | Spray- | 698.5 |
| | reesei | | | | crystal- | |
| | gluco- | | | | lization | |
| | amylase | | | | | |
| Dam004 | Trichoderma | 40 | 36 | 24 | Hot-melt | 685.7 |
| | reesei | | | | Fluidized | |
| | gluco- | | | | bed | |
| | amylase | | | | coating | |
| Dam005 | Trichoderma | 50 | 30 | 20 | Hot-melt | 672.9 |
| | reesei | | | | Fluidized | |
| | gluco- | | | | bed | |
| | amylase | | | | coating | |
| Dam006 | Trichoderma | 60 | 24 | 16 | Hot-melt | 648.1 |
| | reesei | | | | Fluidized | |
| | gluco- | | | | bed | |
| | amylase | | | | coating | |

A publication by Dufreneix et al (J. Dairy Sci. 102:3010-3022, 2019) reported that particles with size diameter of 1, 2 and 3 mm and particle densities in the range of 1.1 to 1.3 g/ml have the shortest mean rumen retention times. Shorter rumen retention time is an advantage for rumen bypass products since the risk of granule degradation or disintegration increases with elongated rumen retention times. The data presented in this Example show that limestone-containing granules have higher density. Limestone was a good carrier for spray drying of Trichoderma reesei glucoamylase ultrafiltration concentrate with 90% activity recovery. The spray dried product was fat coated by fluidized bed coating and this process retained 60 to 90% activity of the spray-dried product.

### Example 4: Effect of Limestone as a Component of the Enzyme Core and Fat Layers Outside the Enzyme Core on Low pH Inactivation of Glucoamylase Enzymes

In this example, the effect of limestone and fat to protect the glucoamylase enzymes from low pH inactivation was measured. To 500 mg of fat coated Trichoderma reesei glucoamylase (TrGA) was added 25 mL of either water at pH adjusted to 1.80 by 5 M HCl or water with 1% (w/v) porcine pepsin (Sigma P7000) and pH adjusted to pH1.81 (corresponding a [H⁺] concentration of 15.8 mM and 15.5 mM, respectively) in 50 ml Falcon tubes. The mixtures were incubated at 40° C. for 3 h with shaking at 215 rpm. At the end of incubation period, the samples were cooled to 25° C. and pH values were measured (Table 15).

For the residual activity assay, 22.5 ml 0.4M MES-NaOH pH6.5 containing 0.01% (w/w) Tween 80 (pH6.5) and 2.5 ml 10% (w/v) sodium dodecyl sulphate (SDS) (pH5.7), were added to each of the 50 ml Falcon tubes having 50 ml reaction mixture which were shaken for 35 mM at 1200 rpm at 22° C. and centrifuged at 4000 rpm for 20 min. About 0.5 ml of a clear solution from the samples were taken and diluted about 5-7 times using 0.2M MES-NaOH (pH6.5) containing 0.01% (w/w) Tween 80. Glucoamylase activity was measured using an amyloglucosidase assay kit containing p-Nitrophenyl β-D-maltoside substrate (Megazyme; R-AMGR3). The reaction was carried out at 32° C. using a TrGA sample of known units/ml as a standard. Absorbance was measured at 400 nm and enzyme activity was expressed as mOD/min. The activity of the fat coated granule extracted with 0.5% (w/v) SDS (pH5.7) was assigned as 100%. Blank samples did not contain any enzyme. Values are an average of N=2 for all measurements. Data for changes in pH values and percent residual activity are shown in Table 15. ND=Not Determined.

TABLE 15
Effect of limestone inside fat-coated GA granules on the
pH of the medium after incubation at 40° C. for 3 h.

| | | | Starting pH | | Activity |
|---|---|---|---|---|---|
| | | | with or | | remaining |
| | | Lime- | without | | associated |
| | Fat, | stone, | 1% (w/v) | Final pH | with the |
| Sample | % | % | porcine | after | fat |
| ID | (w/w) | (w/w) | pepsin | incubation | granule (%) |
| Blank | 0 | 0 | pH1.80 | 1.83 | ND |
| Blank | 0 | 0 | pH1.81 + pepsin | 1.85 | ND |
| Fla0215 | 70 | 0 | pH1.80 | 1.89 | ND |
| Fla0215 | 70 | 0 | pH1.81 + pepsin | 2.11 | ND |
| Dam001 | 70 | 12 | pH1.80 | 5.53 | ND |
| Dam001 | 70 | 12 | pH1.81 + pepsin | 4.29 | ND |
| Dam004 | 40 | 24 | pH1.80 | 5.98 | 7.5 |
| Dam004 | 40 | 24 | pH1.81 + pepsin | 5.55 | 10.6 |
| Dam005 | 50 | 20 | pH1.80 | 4.35 | 69.5 |
| Dam005 | 50 | 20 | pH1.81 + pepsin | 4.22 | 59.6 |
| Dam006 | 60 | 16 | pH1.80 | 2.38 | 94.9 |
| Dam006 | 60 | 16 | pH1.81 + pepsin | 2.72 | 88.5 |

Table 15 shows that the presence of limestone in the granule increased the pH of the 25 ml medium from pH1.80 to the range of pH4.0 to pH6.0 compared to samples lacking limestone (Blank and Fla0215). For Dam004, Dam005 and Dam006, increased fat percentage from 40 to 60% caused less pH increase of the medium and a higher percentage of activity remaining with the granules, indicating better protection of the limestone from hydrolysis and of the TrGA enzyme from low pH inactivation. Hot-melt fluidized bed coated granules (Dam006) gave better protection than spray-crystallization-coated granules (Dam001).

Glucoamylase activity distribution in the aqueous phase before and after adding SDS was measured to determine activity associated with the fat. For samples Dam004, Dam005, and Dam006 samples, increased percentage of fat gave better protection of the Trichoderma reesei glucoamylase in the core since more activity was recovered in the fat associated part with increasing fat content (Table 16). Due to this better protection, the interaction of the limestone inside the fat granule with ambient medium outside the granule was also limited, leading to less pH increase in the medium (about 0.6-0.9 pH units for sample Dam006). The pH increased slightly higher in the presence of 1% pepsin since pepsin is most active at around pH2.0 and the pepsin preparation used was from porcine gastric mucosa (Sigma P7000, lot #BRBR3132V) with a specific activity of >250 units/mg, 10 times lower activity than Sigma P7012 porcine gastric mucosa preparation (2500 units/mg). Table 16 shows that increasing the percentage of fat resulted in higher percentage of activity being associated with the fat fraction. In another words, 60% fat gave the best protection for Trichoderma reesei glucoamylase granules from low pH inactivation.

TABLE 16
Trichoderma reesei glucoamylase units/g found in the
reaction mixture before and after adding SDS for
disrupting the fat granule suspended in the reaction mixture

| | Sample ID | | | | | |
|---|---|---|---|---|---|---|
| | Dam004, 40% fat | | Dam005, 50% fat | | Dam006, 60% fat | |
| | pH | pH 1.81 + | pH | pH 1.81 + | pH | pH 1.81 + |
| Starting pH | 1.80 | 1% pepsin | 1.80 | 1% pepsin | 1.80 | 1% pepsin |
| Total units/g | 893 | 840 | 232 | 284 | 23 | 56 |
| found before | | | | | | |
| SDS extraction | | | | | | |
| Total units/g | 965 | 939 | 761 | 703 | 444 | 491 |
| found after | | | | | | |
| SDS extraction | | | | | | |
| % Residual | 8 | 11 | 70 | 60 | 95 | 89 |
| Activity found | | | | | | |
| associated | | | | | | |
| with fat | | | | | | |

### Example 5: Additional Stability Evaluation of Aspergillus niger and Trichoderma reesei Fat Coated Glucoamylases at pH 2.0 and pH 6.5

Aspergillus niger and Trichoderma reesei glucoamylase granule samples were prepared using either matrix coating or fluidized bed coating technologies as indicated in Table 14. One half gram of fat coated enzyme material was added to either 14.5 ml of 0.2M glycine-HCl buffer at pH2.0 or 0.1M MES-NaOH buffer at pH6.5 in 50 ml Falcon tubes. The suspensions were incubated at 40° C. for 3 h with shaking at 215 rpm. At the end of the incubation period, 33 ml of the 0.1 MES buffer was added to the pH2 tubes and the 0.2M glycine buffer 14.5 ml and the 0.1M MES buffer 18.5 ml were added to the pH6.5 tubes to bring the final volume to 47.5 ml and samples were removed for enzyme activity determination (i.e., −SDS). To these samples were added 2.5 ml 10% SDS (pH5.7) and extracted at 22° C. for 35 min with shaking at 1200 rpm. Residual activity in the SDS extracted phase of these samples (i.e., +SDS) was assayed as described above using the amyloglucosidase assay kit and activity values were corrected to units/g as shown in Table 16.

Table 17 shows glucoamylase activity released in the aqueous phase (−SDS) and after SDS treatment of Aspergillus niger glucoamylase (sample Fla0215) and Trichoderma reesei glucoamylase (samples Dam001, and Dam004-006) samples. At pH 2.0, spray-crystallization coated Fla0215 and Dam001 samples had very low activity in both aqueous and SDS extracted samples compared to their corresponding activities at pH 6.5 incubation. On the other hand, sample Dam001 at pH 2.0 still had 17.6% activity released after SDS compared to pH 6.5 while sample Fla0215 at pH 2.0 even after SDS extraction still had less than 3% of activity than at pH 6.5. Our data shows that A. niger GA was more stable at lower pH than TrGA. For example, after incubation at pH 2.2 for 60 min the AnGA enzyme still retained 80% residual activity while the TrGA enzyme was totally inactivated. This observation indicates that the limestone and fat coating technology protects the enzymes from being inactivated at lower pH, in particular enzymes that exhibit greater sensitivity at lower pH.

TABLE 17
Glucoamylase activity released to the aqueous phase
before and after SDS treatment

| | | U/g | U/g |
|---|---|---|---|
| Sample ID | Incubation pH | −SDS | +SDS |
| Fla0215 | 2 | 2.9 | 2.3 |
| Dam001 | 2 | 2.1 | 61.8 |
| Dam004 | 2 | 424.3 | 631.8 |
| Dam005 | 2 | 5.4 | 316.4 |
| Dam006 | 2 | 2.8 | 465.0 |
| Fla0215 | 6.5 | 99.1 | 85.1 |
| Dam001 | 6.5 | 289.8 | 351.5 |
| Dam004 | 6.5 | 730.3 | 997.2 |
| Dam005 | 6.5 | 406.7 | 801.6 |
| Dam006 | 6.5 | 192.2 | 626.3 |

All the spray-dried enzyme preparations used in this Example had a moisture of less than 5% (w/w). Enzyme preparation with higher moisture made the enzyme preparation mix with the oil difficult to handle. It was additionally found that the enzyme tends to denature between the water oil interface.

### Example 6. Bovine In Vivo Study to Measure the Effect of Dosing Glucoamylase Enzymes as Coated Granules Using Fecal pH as Indicator

An animal trial was conducted at Wageningen University & Research (The Netherlands) to determine the effectiveness of fat coated enzymes in small intestine starch degradation using the titration method described by Gilbert et al., 2015 (Gilbert M S, Van den Borne J J G C, Berends H, Pantophlet A J, Schols H A, Gerrits W J J. 2015. “A titration approach to identify the capacity for starch digestion in milk-fed calves.’ Animals, 9:249-57). Fecal pH was used as the indicator of degree of small intestine starch degradation as indicated in previous publication by Gilbert et al. (2015), where lower small intestine starch digestibility was found to be associated with lower fecal pH in calves.

Young ruminants have a unique digestive system where ingested milk bypasses the rumen and its nutrients will be digested directly by enzymatic actions in the abomasum (true stomach) and lower intestine without the interference from rumen microbes. Therefore, calf was used as the animal model for this trial to study specifically exogenous enzyme efficacy at small intestine.

Calves were housed in groups of 4 per pen on straw bedding and fed milk replacer twice a day at 7.00 h and 16.00 h in individual buckets according to their metabolic BW at twice the metabolizable energy requirement for maintenance (MEm) or according to a feeding scheme. Glucoamylase enzymes were added to the milk replacer in relation to the amount starch added to the replacer: 2.105 mg/g starch for F1a0215 and 1.053 mg/g starch for Dam001. Calves were allowed to consume the milk replacer for at least 10 minutes, after which milk replacer refusals were collected, weighed and recorded if present. Solid feed was provided once a day per pen of calves. Solid feed supply increased with increasing body weight/age. Solid feed refusals were collected, weighed and recorded at every titration step. Water was provided ad libitum.

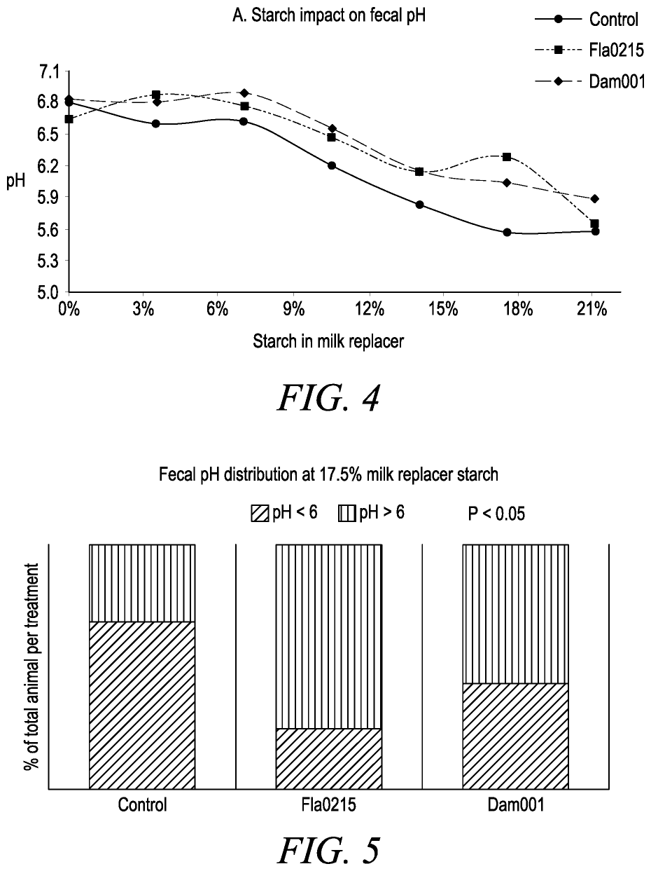

A total of 48 calves weighing ˜80-90 kg BW were used for the replicated 28 d trial (2 periods of 28 d). For each period, 24 calves were blocked by age or body weight and assigned to one of the three dietary treatments: Control (milk replacer with increased amount of starch and decreased amount of lactose), Control+fat coated AnGA (sample Fla0215 described earlier) or Control+fat coated TrGA (sample Dam001 described earlier). In the Control diet, starch was gradually increased in the milk replacer from 0 (i.e., starch-free diet) to 21% at the expense of lactose with 3.5% increment at every 3.5 days. During each titration step, fecal sample was collected from each individual calf in the last 1.5 day. Each fecal sample was analyzed on pH and dry matter (DM) content. The results of the study are summarized on FIG. 4 and Table 18.

FIG. 4 shows the fecal pH as affected by increasing starch in milk replacer and absence (Control diet) or presence of fat coated glucoamylase enzymes.

TABLE 25
Effect of fat coated glucoamylase enzyme granule administration on
overall fecal pH drop when starch in milk replacer was increased.

| | | Minimum milk replacer |
|---|---|---|
| Material | Fecal pH change vs. | starch level for significant |
| Administered | starch-free diet | pH drop |
| Control diet | −0.74 | 1.38% |
| Control diet + AnGA | −0.28 | 7.00% |
| sample Fla0215 | | |
| Control diet + TrGA | −0.44 | 7.00% |
| sample Dam001 | | |
| SEM | 0.119 | NA |
| P-value | 0.0317 | NA |

FIG. 5 shows the distribution of fecal pH in calves receiving milk replacer with 17.5% starch with and without fat coated enzyme inclusion (P<0.05).

The results demonstrate the treatments with fat coated enzymes were able to maintain an overall higher pH as compared to the non-enzyme Control group fed on the Control diet with increasing level of dietary starch (FIG. 4). Fecal pH dropped 0.74, 0.28 or 0.44 overall for calves receiving the Control diet, Control diet+AnGA granule, or the Control diet+TrGA granule treatments, respectively (Table 18, P<0.05). The breakpoint where significant pH drop started was 1.38% of starch from milk replacer, suggesting a low capacity of small intestine enzymatic starch digestion (Table 18). Enzyme inclusions were able to maintain a stable fecal pH up to a starch inclusion level of 7% (Table 18), showing that the exogenous starch degrading enzymes delivered to small intestine can compensate the limited digestive capacity in ruminants. In addition, at high dietary starch inclusion (i.e. 17.5% starch), significantly higher number of calves were having acidic feces (pH<6) in the control group as compared to the 2 enzyme supplemented groups (FIG. 5, P<0.05).

| SEQUENCES | |
|---|---|
| Glucoamylase from Aspergillus fumigatus | |
| SEQ ID NO: 1 | |
| APQLS ARATG SLDSW LGTET TVALN GILAN IGADG AYAKS AKPGI IIASP | |
| STSEP DYYYT WTRDA ALVTK VLVDL FRNGN LGLQR VITEY VNSQA YLQTV | |
| SNPSG GLASG GLAEP KYNVD MTAFT GAWGR PQRDG PALRA TALID FGNWL | |
| IDNGY SSYAV NNIWP IVRND LSYVS QYWSQ SGFDL WEEVN SMSFF TVAVQ | |
| HRALV EGSTF ARRVG ASCSW CDSQA PQILC YMQSF WTGSY INANT GGGRS | |
| GKDAN TVLAS IHTFD PEAGC DDTTF QPCSP RALAN HKVYT DSFRS VYAIN | |
| SGIPQ GAAVS AGRYT EDVYY NGNPW FLTTL AAAEQ LYDAI YQWKK IGSIS | |
| ITSTS LAFFK DIYSS AAVGT YASST STFTD IINAV KTYAD GYVSI VQAHA | |
| MNNGS LSEQF DKSSG LSLSA RDLTW SYAAF LTANM RRNGV VPAPW GAASA | |
| NSVPS SCSMG SATGT YSTAT ATSWP STLTS GSPGS TTTVG TTTST TSGTA | |
| AETAC ATPTA VAVTF NEIAT TTYGE NVYIV GSISE LGNWD TSKAV ALSAS | |
| KYTSS NNLWY VSVTL PAGTT FEYKY IRKES DGSTV WESDP NRSYT VPAAC | |
| GVSTA TENDT WQ. | |
| Glucoamylase from Aspergillus niger | |
| SEQ ID NO: 2 | |
| ATLDS WLSNE ATVAR TAILN NIGAD GAWVS GADSG IVVAS PSTDN PDYFY | |
| TWTRD SGLVL KTLVD LFRNG DTSLL STIEN YISAQ AIVQG ISNPS GDLSS | |
| GAGLG EPKFN VDETA YTGSW GRPQR DGPAL RATAM IGFGQ WLLDN GYTST | |
| ATDIV WPLVR NDLSY VAWYW NQTGY DLWEE VNGSS FFTIA VQHRA LVEGS | |
| AFATA VGSSC SWCDS QAPEI LCYLQ SFWTG SFILA NFDSS RSGKD ANTLL | |
| GSIHT FDPEA ACDDS TFQPC SPRAL ANHKE VVDSF RSIYT LNDGL SDSEA | |
| VAVGR YPEDT YYNGN PWFLC TLAAA EQLYD ALYQW DKQGS LEVTD VSLDF | |
| FKALY SDAAT GTYSS SSSTY SSIVD AVKTF ADGFV SIVET HAASN GSMSE | |
| QYDKS DGEQL SARDL TWSYA ALLTA NNRRN SVVPA SWGET SASSV PGTCA | |
| ATSAI GTYSS VTVTS WPSIV ATGGT TTTAT PTGSG SVTST SKTTA TASKT | |
| STSTS STSCT TPTAV AVTFD LTATT TYGEN IYLVG SISQL GDWET SDGIA | |
| LSADK YTSSD PLWYV TVTLP AGESF EYKFI RTEED DSVEW ESDPN REYTV | |
| PQACG TSTAT VTDTW R. | |
| Glucoamylase from Trichoderma reesei | |
| SEQ ID NO: 3 | |
| 1 | SVDDFISTET PIALNNLLCN VGPDGCRAFG TSAGAVIASP STIDPDYYYM |
| | WTRDSALVFK |
| 61 | NLIDRFTETY DAGLQRRIEQ YITAQVTLQG LSNPSGSLAD GSGLGEPKFE |
| | LTLKPFTGNW |
| 121 | GRPQRDGPAL RAIALIGYSK WLINNNYQST VSNVIWPIVR NDLNYVAQYW |
| | NQTGFDLWEE |
| 181 | VNGSSFFTVA NQHRALVEGA TLAATLGQSG SAYSSVAPQV LCFLQRFWVS |
| | SGGYVDSNIN |
| 241 | TNEGRTGKDV NSVLTSIHTF DPNLGCDAGT FQPCSDKALS NLKVVVDSFR |
| | SIYGVNKGIP |
| 301 | AGAAVAIGRY AEDVYYNGNP WYLATFAAAE QLYDAIYVWK KTGSITVTAT |
| | SLAFFQELVP |
| 361 | GVTAGTYSSS SSTFTNIINA VSTYADGFLS EAAKYVPADG SLAEQFDRNS |
| | GTPLSALHLT |
| 421 | WSYASFLTAT ARRAGIVPPS WANSSASTIP STCSGASVVG SYSRPTATSF |
| | PPSQTPKPGV |
| 481 | PSGTPYTPLP CATPTSVAVT FHELVSTQFG QTVKVAGNAA ALGNWSTSAA |
| | VALDAVNYAD |
| 541 | NHPLWIGTVN LEAGDVVEYK YINVGQDGSV TWESDPNHTY TVPAVACVTQ |
| | VVKEDTWQS. |

Glucoamylase from Wolfiporia cocos
SEQ ID NO: 4
IASESPIAKAGVLANIGADGSLSSGAYSGIVIASPSTV
NPNYLYTWTRDSSLTFMELINQYIYGEDDTLRTLIDEFVSAEATLQQVTNPSGTVSTGGLG
EPKFNINETAFTGPWGRPQRDGPALRATAIMAYATYLYENGNTSYVTDTLWPIIELDLGYV
AEYWNESTFDLWEEIDSSSFFTTAVQHRALRAGVTFANLIGETSDVSNYQENADDLLCFL
QSYWNPTGSYVTANTGGGRSGKDANTLLASIHTFDPDAGCNATTFQPCSDKALSNHKVY
VDSFRSLYAINDDISSDAAVATGRYPEDVYYNGNPWYLCTLAAAEQLYDSLIVWKAQGYIE
VTSLSLAFFQQFDASVSAGTYDSSSDTYTTLLDAVQTYADGFVLMVAQYTPANGSLSEQY
AKADGSPTSAYDLTWSFAAALTAFAARDGKTYGSWGAADLSSTCSGSTDTVAVTFEVQY
DTQYGENLYITGSVSQLEDWSADDALIMSSADYPTWSITVDLPPSTLIQYKYLTKYNGDVT
WEDDPNNEITTPASGSYTQVDSWH.
Glucoamylase from Geosmithia ermersonii
SEQ ID NO: 5
RAPVAARATGSLDSFLATETPIALQGVLNNIGPNGADVAGASAGIVVASPSRSDPNYFYSWTRD
AALTAKYLVDAFIAGNKDLEQTIQQYISAQAKVQTISNPSGDLSTGGLGEPKFNVNETAFTGPW
GRPQRDGPALRATALIAYANYLIDNGEASTADEIIWPIVQNDLSYITQYWNSSTFDLWEEVEGS
SFFTTAVQHRALVEGNALATRLNHTCSNCVSQAPQVLCFLQSYWTGSYVLANFGGSGRSGKDVN
SILGSIHTFDPAGGCDDSTFQPCSARALANHKVVTDSFRSIYAINSGIAEGSAVAVGRYPEDVY
QGGNPWYLATAAAAEQLYDAIYQWKKIGSISITDVSLPFFQDIYPSAAVGTYNSGSTTFNDIIS
AVQTYGDGYLSIVEKYTPSDGSLTEQFSRTDGTPLSASALTWSYASLLTASARRQSVVPASWGE
SSASSVPAVCSATSATGPYSTATNTVWPSSGSGSSTTTSSAPCTTPTSVAVTFDEIVSTSYGET
IYLAGSIPELGNWSTASAIPLRADAYTNSNPLWYVTVNLPPGTSFEYKFFKNQTDGTIVWEDDP
NRSYTVPAYCGQTTAILDDSWQ.

We claim:

1. A granule comprising (a) a core comprising (i) an enzyme; and (ii) a carrier comprising at least one proton acceptor; and (b) one or more layers of one or more fats, wherein the core is coated by the one or more fats and wherein the enzyme maintains at least about 50% residual activity after being coated.

2. The granule of claim 1, wherein the granule is from about 100 μm to about 1500 μm diameter in size.

3. The granule of claim 1 or claim 2, wherein the granule has a particle density from about 0.6 g/mL to about 1.2 g/mL.

4. The granule of any one of claims 1-3, wherein the enzyme maintains at least about 55%, about 60%, about 65%, about 70%, about 75%, about 80%, about 85%, about 90%, about 95%, or about 100% residual activity after being coated.

5. The granule of any one of claims 1-4, wherein the composition has a moisture content of about 5% (w/w) or less.

6. The granule of any one of claims 1-5, wherein the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof.

7. The granule of claim 6, wherein the fat is an animal fat or oil and/or a plant fat or oil.

8. The granule of claim 7, wherein the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil.

9. The granule of claim 7, wherein the plant fat or oil is selected from the group consisting of fully hardened palm oil, fully hardened rapeseed oil, fully hardened cottonseed oil and fully hardened soybean oil.

10. The granule of claim 8 or claim 9, wherein the plant fat or oil is palm oil or fully hardened palm oil.

11. The granule of any one of claims 1-10, wherein the fat has a melting point of about 40° C. to about 80° C.

12. The granule of any one of claim 1-11, wherein the enzyme is one or more selected from the group consisting of acetyl esterases, aminopeptidases, amylases, arabinases, arabinofuranosidases, carboxypeptidases, catalases, cellulases, chitinases, chymosin, lysozymes, cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, mannanase, and combinations thereof.

13. The granule of claim 12, wherein the enzyme is a glucoamylase.

14. The granule of claim 13, wherein the glucoamylase is derived from a filamentous fungus, optionally comprising the polypeptide of SEQ ID NO:1, SEQ ID NO:2, or SEQ ID NO:3.

15. The granule of any one of claims 1-14, wherein the carrier comprises sodium carbonate (Na₂CO₃), sodium bicarbonate (NaHCO₃), calcium carbonate (CaCO₃), magnesium carbonate (MgCO₃), sodium acetate (CH₃COONa), and/or calcium acetate (Ca(C₂H₃O₂)₂).

16. The granule of claim 15, wherein the carrier comprises limestone.

17. The granule of any one of claims 1-16, wherein the granule comprises from about 30% to about 70% (w/w) fat content.

18. The granule of any one of claims 1-17, wherein the granule comprises from about 10% to about 30% (w/w) carrier content.

19. The granule of any one of claims 1-18, wherein the granule comprises from about 10% to about 40% (w/w) enzyme content.

20. A feed additive composition comprising the granule of any one of claims 1-19.

21. The composition of claim 20, wherein the composition further comprises an essential oil.

22. The composition of claim 21, wherein the essential oil comprises thymol and/or cinnamaldehyde.

23. The composition of any one of claims 20-22, wherein the composition further comprises betaine or a feed acceptable salt or hydrate thereof.

24. The composition of any one of claims 20-23, wherein the composition further comprises at least one direct fed microbial (DFM).

25. The composition of claim 24, wherein the DFM is a viable bacterium.

26. The composition of claim 24 or claim 25, wherein the composition comprises at least three DFMs.

27. The composition of claim 25, wherein the DFMs comprise Bacillus strain 2084 Accession No. NRRL B-50013, Bacillus strain LSSAO1 Accession No. NRRL B-50104 and Bacillus strain 15A-P4 ATCC Accession No. PTA-6507.

28. The composition of any one of claims 24-27, wherein the DFM is present in the feed additive composition in a range from about 2.5×10³ CFU to about 6.7×10⁶ CFU.

29. The composition of any one of claims 20-28, wherein the composition further comprises one or more of a phage, a prebiotic, and/or a carbohydrate immune stimulant.

30. A feed comprising the granule of any one of claims 1-19 or the feed additive composition of any one of claims 20-29.

31. The feed of claim 30, further comprising an animal protein, a vegetable protein, corn, soybean meal, corn dried distillers grains with solubles (cDDGS), wheat, wheat proteins, gluten, wheat by products, wheat bran, wheat dried distillers grains with solubles (wDDGS), corn by products including corn gluten meal, barley, oat, rye, triticale, full fat soy, animal by-product meals, an alcohol-soluble protein, a zein, a maize zein maize, a kafirin, rice, paddy rice, extruded paddy rice, a protein from oil seeds, or a combination thereof.

32. The feed of claim 31, wherein the animal protein or vegetable protein is selected from the group consisting of one or more of a gliadin or an immunogenic fragment of a gliadin, a beta-casein, a beta-lactoglobulin, glycinin, beta-conglycinin, cruciferin, napin, hordeins, keratins, feather or hair meals, collagen, whey protein, fish protein, fish meals, meat protein, egg protein, soy protein and grain protein.

33. The feed of claim 31, wherein the protein from oil seeds is selected from the group consisting of soybean seed proteins, sun flower seed proteins, rapeseed proteins, canola seed proteins and combinations thereof.

34. A premix comprising a) i) the granule of any one of claims 1-19; ii) or the feed additive composition of any one of claims 20-29; and b) at least one mineral and/or at least one vitamin.

35. A kit comprising a) i) the granule of any one of claims 1-19; ii) the feed additive composition of any one of claims 20-29; iii) the feed of any one of claims 30-33; and/or iv) the premix of claim 34; and b) instructions for formulating and/or administrating to a subject.

36. A method for improving the performance of a subject comprising administering to the subject an effective amount the feed additive composition of any one of claims 20-29 or the feed of any one of claims 30-33, wherein improving the performance of a subject comprises of one or more of (a) improved feed conversion ratio (FCR); (b) improved weight gain; (c) improved feed efficiency; (d) improved carcass quality; and/or (e) improved milk production compared to the performance of a subject that has not been administered the feed additive composition.

37. A method for one or more of a) increasing starch digestibility; and/or b) lowering fecal starch output; and/or c) preventing a decrease in the pH in the lower gastrointestinal tract in a subject comprising adding an effective amount of a feed additive composition comprising the coated granule of any one of claims 1-19 to a feed for administration to a subject, wherein the subject exhibits one or more of increased starch digestibility and/or lowered fecal starch output compared to a subject that has not been administered the feed additive composition.

38. The method of claim 36 or claim 37, wherein the subject is a ruminant.

39. The method of claim 38, wherein the ruminant is selected from the group consisting of cattle, goats, sheep, giraffes, deer, gazelles, and antelopes.

40. The method of claim 39, wherein the cattle are beef cattle or dairy cattle.

41. The method of any one of claims 36-40, wherein the feed further comprises an animal protein, a vegetable protein, corn, soybean meal, corn dried distillers grains with solubles (cDDGS), wheat, wheat proteins, gluten, wheat by products, wheat bran, wheat dried distillers grains with solubles (wDDGS), corn by products including corn gluten meal, barley, oat, rye, triticale, full fat soy, animal by-product meals, an alcohol-soluble protein, a zein, a maize zein maize, a kafirin, rice, paddy rice, extruded paddy rice, a protein from oil seeds, or a combination thereof.

42. A method for manufacturing a coated enzyme granule comprising coating a core comprising (i) an enzyme; and (ii) a carrier comprising at least one proton acceptor with one or more layers of one or more fats.

43. The method of claim 42, wherein the core is coated by a process selected from the group consisting of spray cooling, spray chilling, spray freezing, and hot melt fluid bed coating.

44. The method of claim 42, wherein the granule is from about 100 μm to about 1500 μm diameter in size.

45. The method of any one of claims 42-44, wherein the granule has a particle density from about 0.6 g/mL to about 1.2 g/mL.

46. The method of any one of claims 42-45, wherein the enzyme maintains at least about 55%, about 60%, about 65%, about 70%, about 75%, about 80%, about 85%, about 90%, about 95%, or about 100% residual activity after being coated.

47. The method of any one of claims 42-46, wherein the composition has a moisture content of about 5% (w/w) or less.

48. The method of any one of claims 42-47, wherein the coating is a fat is selected from the group consisting of animal oils or fats, vegetable oils or fats, triglycerides, free fatty acids, animal waxes, beeswax, lanolin, shell wax, Chinese insect wax, vegetable waxes, carnauba wax, candelilla wax, bayberry wax, sugarcane wax, mineral waxes, synthetic waxes, natural and synthetic resins, and mixtures thereof.

49. The method of claim 48, wherein the fat is an animal fat or oil and/or a plant fat or oil.

50. The method of claim 49, wherein the plant fat or oil is selected from the group consisting of canola oil, cottonseed oil, peanut oil, corn oil, olive oil, soybean oil, sunflower oil, safflower oil, coconut oil, palm oil, linseed oil, tung oil, castor oil and rapeseed oil.

51. The method of claim 49, wherein the plant fat or oil is selected from the group consisting of fully hardened palm oil, fully hardened rapeseed oil, fully hardened cottonseed oil and fully hardened soybean oil.

52. The method of claim 50 or claim 51, wherein the plant fat or oil is palm oil or fully hardened palm oil.

53. The method of any one of claims 42-52, wherein the fat has a melting point of about 40° C. to about 80° C.

54. The method of any one of claim 42-53, wherein the enzyme is one or more selected from the group consisting of acetyl esterases, aminopeptidases, amylases, arabinases, arabinofuranosidases, carboxypeptidases, catalases, cellulases, chitinases, chymosin, lysozymes , cutinase, deoxyribonucleases, epimerases, esterases, α-galactosidases, β-glucanases, glucan lysases, endo-β-glucanases, glucoamylases, glucose oxidases, β-glucosidases, glucuronidases, hemicellulases, hexose oxidases, hydrolases, invertases, isomerases, laccases, lyases, mannosidases, oxidases, oxidoreductases, pectinases, pectate lyases, pectin acetyl esterases, pectin depolymerases, pectin methyl esterases, pectinolytic enzymes, peroxidases, phenoloxidases, polygalacturonases, acid proteases, neutral proteases, alkaline proteases, rhamno-galacturonases, ribonucleases, transglutaminases, xylanases, endo-1.4-α-xylanase (EC 3.2.1.8), hexose oxidase (D-hexose: 02-oxidoreductase, EC 1.1.3.5), cellobiohydrolase, acid phosphatases, phytases, lipolytic enzymes, mannanase, and combinations thereof.

55. The method of claim 54, wherein the enzyme is a glucoamylase.

56. The method of claim 55, wherein the glucoamylase is derived from a filamentous fungus, optionally comprising the polypeptide of SEQ ID NO:1, SEQ ID NO:2, SEQ ID NO:3, SEQ ID NO:4, or SEQ ID NO:5.

57. The method of any one of claims 42-56, wherein the carrier comprises sodium carbonate (Na₂CO₃), sodium bicarbonate (NaHCO₃), calcium carbonate (CaCO₃), magnesium carbonate (MgCO₃), sodium acetate (CH₃COONa), and/or calcium acetate (Ca(C₂H₃O₂)₂).

58. The method of claim 57, wherein the carrier comprises limestone.

59. The method of any one of claims 42-58, wherein the granule comprises from about 30% to about 70% (w/w) fat content.

60. The method of any one of claims 42-59, wherein the granule comprises from about 10% to about 30% (w/w) carrier content.

61. The method of any one of claims 42-60, wherein the granule comprises from about 10% to about 40% (w/w) enzyme content.

62. The method of any one of claims 42-61, further comprising coating the enzyme granule with an essential oil.

63. The method of claim 62, wherein the essential oil comprises thymol and/or cinnamaldehyde.

64. The method of any one of claims 42-63, further comprising coating the enzyme granule with betaine or a feed acceptable salt or hydrate thereof.

65. A method for decreasing the transit time of an enzyme or active agent through the rumen of a ruminant animal comprising administering the coated granule of any one of claims 1-19 to the ruminant animal, wherein the proton acceptor comprises limestone and wherein the transit time of the enzyme through the rumen is decreased compared to the transit time through the rumen of an enzyme that is not administered as part of the coated granule of any one of claims 1-19.
